(19) United States
(12) Patent Application Publication
(10) Pub. No.: US 2006/0134509 A1
(43) Pub. Date: Jun. 22, 2006

(54) Method and apparatus for metal coated silicon fuel cell electrode

(75) Inventors: Kumnith Ping, Beaverton, OR (US); Slobodan Petrovic, Scottsdale, AZ (US); Brett D. Vinsant, Hillsboro, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ClearEdge Power, Inc., Hillsboro, OR (US)

(21) Appl. No.: 11/323,047

(22) Filed: Dec. 29, 2005

Related U.S. Application Data
(63) Continuation-in-part of application No. 10/555,037.
(60) Provisional application No. 60/538,150, filed on Jan. 20, 2004.

(51) Int. Cl. H01M 4/86; H01M 4/92; H01M 4/88; H01M 8/02

(52) U.S. Cl. 429/44; 429/39; 427/115

(57) ABSTRACT

According to one embodiment of the invention, an intermediate binding layer and a metal layer can be deposited on a silicon electrode that has been configured with a flow field for a fuel cell. The metal provides high conductivity for the electrode and can also prevent degradation of the silicon. The intermediate binding layer allows the metal to be coupled with the silicon. As one example, tantalum can be used as the intermediate layer and gold can be used as the covering layer.

This application is a continuation-in-part of U.S. patent application Ser. No. 10/555,037, filed on Oct. 27, 2005 and entitled “Fuel Cell System”, which claimed the benefit of PCT/US2005/001618 filed on Jan. 19, 2005 entitled “Fuel Cell System”, which claimed the benefit under 35 U.S.C. § 119(e) of U.S. provisional application 60/538,150 filed on Jan. 20, 2004; and, this application is a continuation-in-part of PCT/US2005/001618 filed on Jan. 19, 2005. The content of all of the aforementioned applications are all hereby incorporated by reference in their entirety and for all purposes.

Embodiments of the invention relate generally to fuel cell electrodes. For example, according to one embodiment of the invention, metal coated silicon fuel cell electrodes are utilized.

### BACKGROUND

In the past, solid carbon or metal flow field plates have been utilized as the electrodes for fuel cells. While such flow field plates are durable and conduct electrons well, they are thick and/or heavy. Furthermore, some types of metal are often etched by the corrosive elements present in a fuel cell environment—thus the electrodes can be etched by the corrosive effects, as well. Due to the thickness and weight of these solid carbon or solid metal fuel cell electrodes, the resulting fuel cell stack is quite large and heavy. Also, in carbon and metal fuel cell electrodes, the flow field pattern that can be formed on the electrode is very limited by what can be etched or stamped into the carbon or metal electrode. Oftentimes, this is a less than ideal pattern that does not provide the greatest efficiency in circulating the reactant gases used by the fuel cell.

One solution recently presented by the inventors is the use of silicon substrate electrodes. The silicon can be fabricated by silicon processing techniques that allow very intricate patterns to be etched from the silicon. For example, a pillar shaped flow field pattern can be created by the use of such techniques that simply could not be easily accomplished using a carbon or metal flow field plate. In addition, the silicon processing can be performed on a silicon wafer so as to produce a flow field plate that is extremely thin and light weight when compared to solid carbon or solid metal flow field plates.

However, over long-term use, silicon can be etched by the corrosive environment present during long-term operation of a fuel cell. This can produce hot spots during operation that lead to long term degradation of the fuel cell. In the case of a fuel cell that operates with phosphoric acid, for example, the phosphoric acid can etch the silicon. In addition, silicon is a semiconductor. While it does conduct electrical current, it will not do so with the conductivity of pure metal or pure carbon.

### BRIEF SUMMARY

According to one embodiment of the invention, a silicon fuel cell electrode is provided that comprises a layer of metal disposed over the silicon. The metal can be deposited over the silicon via an intermediate adhesion layer. The metal can be used to enhance the conductivity of the fuel cell electrode and prevent damage to the silicon from the corrosive operating environment of a fuel cell.

According to another embodiment of the invention, a method of making a fuel cell is provided. A fuel cell flow field plate can first be configured from silicon using silicon processing techniques. An intermediate adhesion layer and a metal covering layer can then be deposited over the silicon to enhance the conductivity of the flow field plate. In addition, the metal can be used to protect the silicon from damage during use in a fuel cell environment.

In accordance with one embodiment of the invention, catalyst can be deposited on the metal for use in serving as a catalyst for reactant gases used during fuel cell operations.

In yet another embodiment, a membrane material can be deposited on the metal to retain electrolyte, such as phosphoric acid, during use in a fuel cell environment.

Further embodiments will become apparent to one of ordinary skill in the art from a review of the specification, drawings, and claims.

### BRIEF DESCRIPTION OF THE DRAWINGS

FIG. 1 is a schematic diagram of a fuel cell system according to a disclosed embodiment.

FIG. 2 is a diagram of a fuel cell module according to a disclosed embodiment.

FIG. 3 is a side plan view of a fuel reactor according to a disclosed embodiment.

FIG. 4 is a perspective view of the fuel reactor of FIG. 3 with a portion of the reactor housing broken away.

FIG. 5 is a front perspective view of a fuel cell system according to a disclosed embodiment.

FIG. 6 is a perspective view of a fuel cell module and a corresponding backing plate according to the disclosed embodiment depicted in FIG. 5.

FIG. 7 is an exploded rear perspective view of the fuel cell module and backing plate of FIG. 6.

FIG. 8 is a perspective view of a right module block from the fuel cell module of FIG. 6.

FIG. 9 is another perspective view of the right module block of FIG. 8.

FIG. 10 is a perspective view of a left module block from the fuel cell module of FIG. 6.

FIG. 11 is another perspective view of the left module block of FIG. 10.

FIG. 12 is a side plan view of a fuel cell stack from the fuel cell module of FIGS. 6-7.

FIG. 13 is a side broken-away sectional view of a fuel cell taken along line 13-13 of FIG. 2.

FIG. 14 is a perspective view of a portion of a face of a fuel cell silicon substrate, including an arrangement of pillars according to a disclosed embodiment.

FIG. 15 is a plan view of a fuel cell silicon substrate according to a disclosed embodiment.

FIG. 16 is an enlarged view of a portion of the silicon substrate of FIG. 15.

FIG. 17 is a schematic, partially exploded, broken-away sectional view of the fuel cell of FIG. 13.

FIG. 18 is a side broken-away sectional view of a silicon substrate having an oxide layer formed thereon.

FIG. 19 is a side broken-away sectional view of the silicon substrate of FIG. 18 having a pattern of resist material formed on the oxide layer.

FIG. 20 is a side broken-away sectional view of the silicon substrate of FIG. 19 having a trench pattern formed in areas not protected by the resist material.

FIG. 21 is a side broken-away sectional view of the silicon substrate of FIG. 20 with the resist material removed.

FIG. 22 is a side broken-away sectional view of the silicon substrate of FIG. 21 with a ring of resist material formed on the oxide layer.

FIG. 23 is a side broken-away sectional view of the silicon substrate of FIG. 22 with the oxide layer removed in areas not protected by the ring of resist material, forming a ring of oxide material.

FIG. 24 is a side broken-away sectional view of the silicon substrate of FIG. 23 with a catalyst binding layer formed thereon.

FIG. 25 is a side broken-away sectional view of the silicon substrate of FIG. 24 wherein part of the catalyst binding layer has been processed.

FIG. 26 is a side broken-away sectional view of the silicon substrate of FIG. 25 with the portion of the catalyst binding layer that covered the oxide ring having been removed.

FIG. 27 is a side broken-away sectional view of the silicon substrate of FIG. 26 with a lift-off layer formed on the oxide ring.

FIG. 28 is a side broken-away sectional view of the silicon substrate of FIG. 27 with a catalyst layer formed thereon.

FIG. 29 is a side broken-away sectional view of the silicon substrate of FIG. 28 with the lift-off layer and the catalyst material deposited on the lift-off layer removed.

FIG. 30 is a side broken-away sectional view of the silicon substrate of FIG. 29 with a contact binding layer and a contact layer formed on the silicon substrate opposite the catalyst layer to form top and bottom fuel cell assemblies according to the embodiment of FIG. 17.

FIG. 31 is an exploded side broken-away sectional view of a middle fuel cell assembly according to the embodiment of FIG. 17.

FIG. 32 is a side broken-away sectional view of the middle assembly of FIG. 31.

FIG. 33 is a schematic diagram of a fuel cell system according to a disclosed embodiment of the invention, depicting controls for the modules of the system.

FIG. 34 is a schematic diagram of a fuel cell module from the embodiment of FIG. 33.

FIGS. 35A and 35B illustrate fabrication of a carbon coated silicon electrode for a fuel cell in accordance with one embodiment of the invention.

FIG. 36 illustrates a flowchart demonstrating a method of fabricating a carbon coated fuel cell electrode in accordance with one embodiment of the invention.

FIGS. 37A, 37B, and 37C illustrate fabrication of a metal coated silicon electrode for a fuel cell in accordance with one embodiment of the invention.

FIG. 38 illustrates a flowchart demonstrating a method of fabricating a metal coated silicon electrode for a fuel cell in accordance with one embodiment of the invention.

FIG. 39 illustrates an example of a flowchart demonstrating a method of fabricating a metal coated silicon electrode in accordance with one embodiment of the invention.

FIGS. 40A and 40B illustrate fabrication of an electrode comprising catalyst and electrolyte retaining material, in accordance with one embodiment of the invention.

FIGS. 41A and 41B illustrate a method for a carbon covered silicon electrode in accordance with one embodiment of the invention.

FIGS. 42A and 42B illustrate a method for a metal covered silicon electrode in accordance with one embodiment of the invention.

FIG. 43A, 43B, 43C, 43D, 43E illustrate a flow field plate and a method of configuring a flow field plate in accordance with one embodiment of the invention.

FIG. 44 illustrates a fuel cell implemented without a gas diffusion layer in accordance with one embodiment of the invention.

FIG. 45 illustrates a flow chart demonstrating a method of forming a flow field plate in accordance with one embodiment of the invention.

FIGS. 46A and 46B illustrate a flow chart demonstrating a method of forming a fuel cell in accordance with one embodiment of the invention.

### DETAILED DESCRIPTION

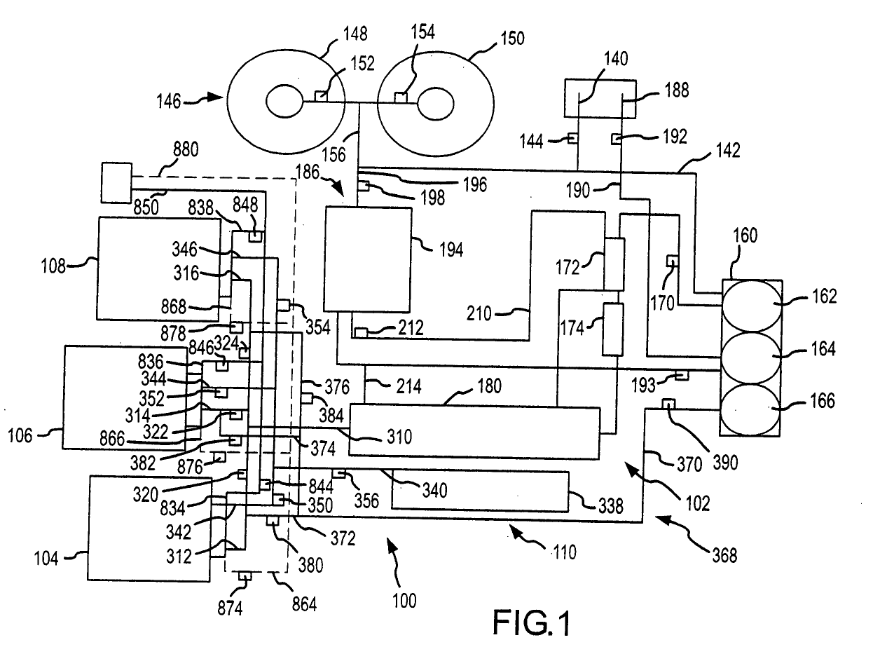

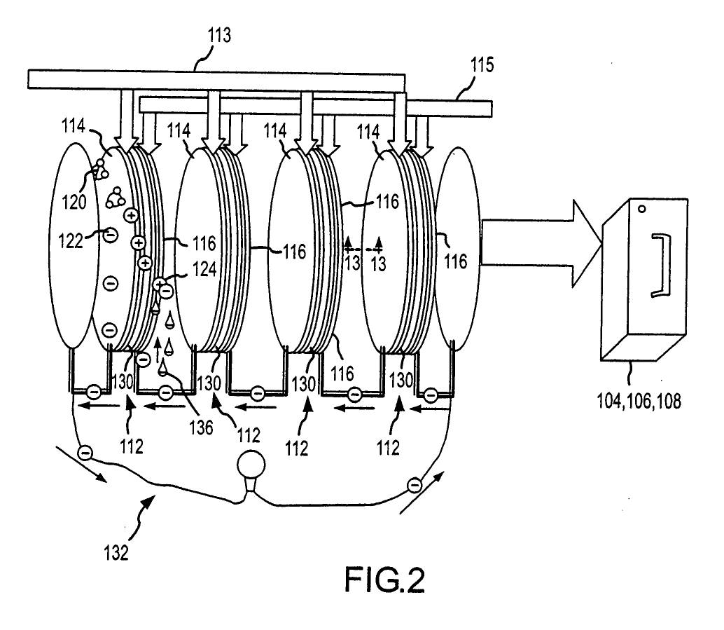

Referring to FIG. 1, a fuel cell system 100 includes a hydrogen generation sub-system (sometimes called “balance of plant”) 102 that generates hydrogen gas (H₂). The H₂ gas is supplied continuously to fuel cell modules 104, 106, 108. Additionally, an air supply sub-system 110 continuously supplies air to the fuel cell modules 104, 106, 108. As depicted in FIG. 2, each module 104, 106, 108 includes multiple disc-shaped fuel cells 112 that receive the H₂ gas 113 on an anode side 114 and air 115 on an opposite cathode side 116. At the anode side 114, the hydrogen atoms 120 are encouraged to release their electrons 122 and become hydrogen ions (protons, H⁺) 124 with the following reaction:
2H₂→4H⁺+4e⁻

The protons 124 pass through a proton-exchange membrane 130 to reach the cathode side 116. The electrons 122 are forced to take a different path around the membrane, through an electric circuit 132, thereby producing electric power. At the cathode side 116, another reaction takes place as the protons 124 and electrons 122 combine with the oxygen gas (O₂ from air 115) to produce fuel cell exhaust (water 136) with the following reaction:
O₂+4H⁺+4e⁻>2H₂O

The electric circuit 132 may include various electric components depending on the desired uses for the current produced by the fuel cells 112. For example, the circuit 132 may include switches, inverters, capacitors, and batteries.

Referring back to FIG. 1 and describing the fuel cell system 100 in more detail, the hydrogen generation sub-system 102 includes a main hydrocarbon fuel supply 140, which can be a standard natural gas outlet. Alternatively, the fuel supply 140 could be a supply of another hydrocarbon fuel such as methanol or propane. Hydrogen also could be provided by some other type of hydrogen generating system, such as a pressure or thermal swing adsorption device. Moreover, the fuel supply 140 could supply hydrocarbon fuel in gaseous or liquid form. A main fuel line 142 leads from the fuel supply 140. The main fuel line 142 and all other fuel and hydrogen lines mentioned herein preferably, but not necessarily, are one-quarter inch stainless steel lines. Supply lines made from other materials, such as polymeric materials, also can be used. Fuel line 142 may include a main fuel valve 144, which is located on the main fuel line 142. The main fuel valve 144 and other valves mentioned herein can be standard solenoid-actuated stainless steel shut-off valves.

A backup fuel supply 146 provides a backup supply of fuel if there is an interruption in the main fuel supply 140. The backup supply 146 includes a pair of propane tanks 148, 150, each having a respective shut-off valve 152, 154 between the tank 148, 150 and a backup fuel line 156. The backup fuel line 156 leads to the main fuel line 142. Notably, the system 100 can use many types of hydrocarbon fuels, such as natural gas, propane, and methanol, interchangeably. Thus, the system 100 can be switched from a main natural gas supply to a backup propane supply without interrupting the production of electric power. In alternative embodiments, either the backup fuel supply 146 or the main fuel supply 140 may be omitted.

For the disclosed embodiment, the main fuel line 142 leads to a filter pack 160. In one embodiment, the filter pack 160 is a manifold with screw-in attachments for a fuel filter 162, a water filter 164, and a cleaning fluid supply 166. The fuel filter 162 may include an activated carbon filter that removes sulfur from the incoming fuel (such sulfur is typically added to make the fuel detectable). From the fuel filter 162, the main fuel line 142 has an additional vaporizer shut-off valve 170 before reaching a fuel vaporizer 172. The fuel vaporizer 172 is a vaporizer that is able to vaporize hydrocarbon fuels such as propane and natural gas. In one embodiment, the vaporizer is the model number 0125A vaporizer available from Impco Technologies, Inc. of Cerritos, Calif. However, other types of vaporizers may be used so long as they are able to vaporize hydrocarbon fuels.

The main fuel line 142 continues from the vaporizer 172 through a pressure regulator 174, and then to a reactor 180. The pressure regulator 174 can be any of various standard pressure regulators. In one embodiment, the pressure regulator 174 is a pressure regulator sold under model number 300312 by Impco Technologies, Inc. of Cerritos, Calif. The pressure of the fuel as it leaves the pressure regulator 174 (the exit pressure) is typically about the same as the pressure of the H₂ gas delivered to the modules 104, 106, 108. The exit pressure of the pressure regulator 174 is set so that it will produce a sufficient flow of H₂ gas through the modules 104, 106, 108 so that power production is maximized, but all the hydrogen is used in the reaction within the fuel cells 112. In one embodiment the exit pressure of the pressure regulator 174 is between 5 pounds per square inch and 10 pounds per square inch, most typically about 8 pounds per square inch.

The vaporizer 172 and the reactor 180 may be heated by steam produced in a water supply sub-system 186 of the hydrogen generation sub-system 102. The water supply sub-system 186 includes a water supply source 188, which can be a standard water faucet connected to a municipal water system. A main water line 190 extends from the water supply source 188 through a main water shut-off valve 192 and to an optional water filter 164. The water filter 164 can be a standard water filter such as the filters commonly found in ice makers. Alternatively, the water filter may be a reverse osmosis water filter or some other type of filter to increase the purity of the water.

From the water filter 164, the main water line 190 leads through a shut-off valve 193, and to a pre-heater 194. In one embodiment, the pre-heater 194 is a boiler that delivers steam at from about 240° Fahrenheit to about 400° Fahrenheit, depending on how much heat is needed in the vaporizer 172 and the reactor 180. The pre-heater 194 receives fuel from the main fuel supply 140 or the backup fuel supply 146 through a pre-heater fuel supply line 196, which has a shut-off valve 198. The pre-heater 194 ignites the fuel to heat incoming water and thereby produce steam. A steam supply line 210 leads from the pre-heater 194, through a shut-off valve 212, and to the vaporizer 172. The steam supply line 196 extends from the vaporizer 172 to the reactor 180. A water return line 214 exits the reactor 180 and returns water to the pre-heater 194.

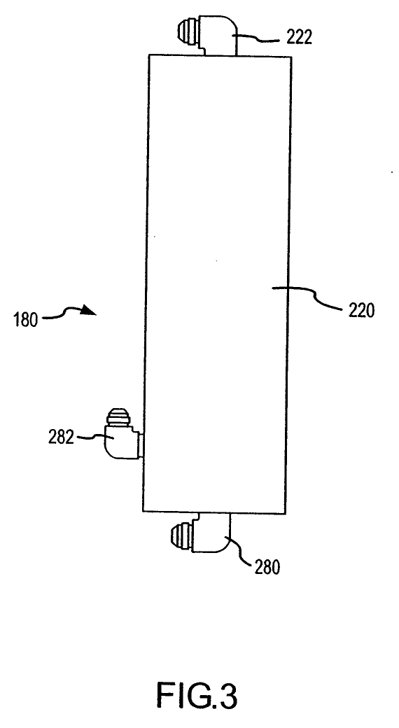

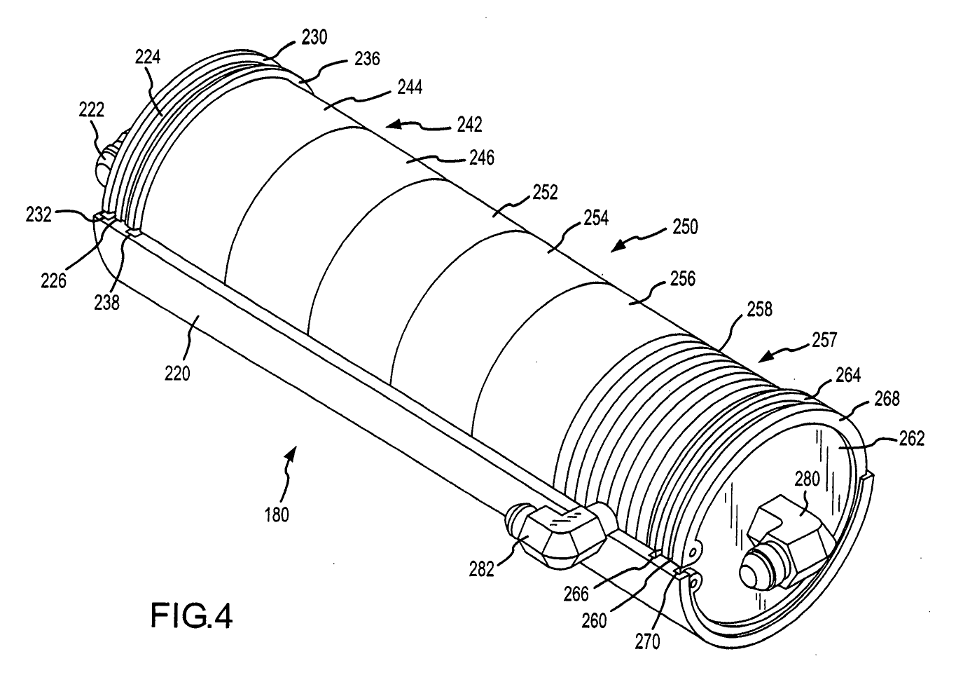

In one embodiment, the reactor 180 is a catalyst reactor that produces H₂ gas from hydrocarbon fuel and steam. Referring to FIGS. 3-4, the reactor 180 includes a housing 220, which in the disclosed embodiment is a cylindrical tube. The housing 220 is made of a rigid material, such as stainless steel. Referring to FIG. 4, a reactor inlet fitting 222 at the rear of the reactor 180 is connected to the steam supply line 210 and to the main fuel line 142 (FIG. 1). The reactor inlet fitting 222 is fitted into an inlet disc or puck 224 that is seated within the rear of the housing 220. The inlet puck 224 abuts an inlet O-ring 226 that is located forward from the puck 224. A first lock ring 230 engages a first inward-facing lock ring groove 232 in the inside surface at the rear of the housing 220, and a second lock ring 236 engages a second inward-facing lock ring groove 238 in the housing 220 forward from the first lock ring 230. The inlet puck 224 and the inlet O-ring 226 are sandwiched between the first lock ring 230 and the second lock ring 236.

A cylindrical activated carbon filter 242 includes a rear carbon filter section 244 and a front carbon filter section 246. The rear carbon filter section 244 is located forward from the second lock ring 236, and the front carbon filter section 246 is located forward, or downstream, from the rear carbon filter section 244. For the disclosed embodiment, the carbon filter sections 244, 246 are type CI sodium hydroxide (NaOH) activated carbon filters. The filter sections 244, 246 may be solid media, such as the 6×12 compressed media mesh filters available from Cameron Great Lakes of Portland, Oreg. Alternatively, the sections 244, 246 may be loose media, such as one-sixteenth inch loose media.

A catalyst filter 250 is located forward (downstream) from the carbon filter 242. The catalyst filter 250 yields hydrogen gas from hydrocarbon fuels by introducing a mixture of water and hydrocarbon fuel to catalysts. The catalyst filter 250 includes a catalyst or mixture of catalysts that catalyze reaction of hydrocarbon fuels to produce hydrogen, and that will catalyze reactions of byproducts of the hydrocarbon fuel reaction, which are captured in the filter 250 or exhausted from the reactor 180. Moreover, the catalyst filter 250 is preferably constructed of materials that allow the passage of hydrogen but inhibit the passage of byproducts, including hydrocarbon fuel impurities. The catalyst filter 250 has a first catalyst filter section 252, a second catalyst filter section 254 located forward from the first section 252, and a third catalyst filter section 256 located forward from the second section 254. The first catalyst filter section 252 includes an extruded ceramic honeycomb structure similar to structures used in many reverse osmosis filter systems. The ceramic structure is coated with platinum and tin. The tin and platinum may be sputtered or evaporated onto the ceramic structure, although other coating processes also can be used. In one embodiment, the coating in the first catalyst filter section 252 is about ninety percent platinum and about ten percent tin.

The second catalyst filter section 254 also may be a ceramic honeycomb structure similar to the first catalyst filter section 252. The ceramic structure is coated with ruthenium and platinum. The ruthenium and platinum may be sputtered or evaporated onto the ceramic membranes, although other coating methods also can be used. In one embodiment, the coating in the second catalyst filter section 254 is about ninety percent platinum and about ten percent ruthenium.

Similarly, in one embodiment the third catalyst filter section 256 is a ceramic honeycomb structure, but is coated with platinum and chromium trioxide (CrO₃). The platinum and chromium trioxide may be sputtered or evaporated onto the ceramic structure. In one embodiment, the coating in the third catalyst filter section 256 is about seventy percent platinum and about thirty percent chromium trioxide.

A membrane filter 257 includes a series of membrane discs or plates 258 that are located forward from the catalyst filter 250. The membrane discs or plates 258 are constructed to catalyze reactions that will further purify, where desired or necessary, hydrogen gas produced in the catalyst filter 250, and that will allow hydrogen gas to pass through while blocking the passage of other gases. In one embodiment, the reactor 180 includes ten membrane plates 258 that are copper discs coated with platinum.

Forward from the membrane discs 258 is an outlet O-ring 260 and an outlet disc or puck 262. The O-ring 260 and the outlet disc 262 are sandwiched between a third lock ring 264 that engages a third lock ring groove 266 in the housing 220 and a fourth lock ring 268 that engages a fourth lock ring groove 270. An outlet fitting 280 is centrally located in the outlet disc 262, allowing hydrogen to exit the reactor 180.

A waste fitting 282 passes through the side of the housing 220 adjacent to the membrane plates 258. The diameters of the filters 242, 250, 257 are generally less than the inner diameter of the housing so that gaps or flow conduits are formed between the housing 220 and the filters 242, 250, 257, allowing byproducts of reactions within the reactor 180, including impurities from the hydrocarbon fuel, to be exhausted from the reactor 180. Notably, most byproducts (other than unreacted water) are retained by the filters 242, 250, 257. More specifically, the byproducts typically bond to the catalysts within the filters 242, 250, 257. The exhaust from the reactor 180 typically is substantially water, although it generally includes very small quantities of carbon dioxide (typically on the order of about 5 ppm), and even smaller quantities of other byproducts.

Referring back to FIG. 1, the exhaust that exits through the waste fitting 282 of FIGS. 3-4 goes into the water return line 214 and back to the pre-heater 194 via the main water line 190. A main hydrogen supply line 310 leads from the outlet fitting 280 in the reactor 180 and branches into multiple module hydrogen supply lines 312, 314, 316, with each module supply line leading to a single module 104, 106, 108, respectively. The main hydrogen supply line 310 may branch by feeding into a manifold with multiple exits, or it may branch by simply using “T” fittings or other branching fittings. Each module supply line 312, 314, 316 includes a respective module hydrogen supply valve 320, 322, 324.

The air supply sub-system 110 includes an air source 338, such as an air supply fan. In one embodiment, air source 338 is a twenty-four volt fan that is able to produce a flow of air through a main air supply line 340. Alternatively, the air source 338 could be an air pump or a pressurized air tank. Additionally, another source of oxidant, such as pure oxygen gas, could be used in place of air. In the disclosed embodiment, main air supply line 340 is a one-half inch stainless steel line, although other suitable materials also can be used. The main air supply line 340 branches into multiple module air supply lines 342, 344, 346. As with the module hydrogen supply lines 312, 314, 316, the main air supply line 340 may branch by feeding into a manifold with multiple exits or it may branch by simply using “T” fittings or other branching fittings. Each illustrated module air supply line 342, 344, 346 includes a respective module air supply valve 350, 352, 354. Additionally, the main air supply line 340 includes a main air shut-off valve 356.

A cleaning fluid supply sub-system 368 includes a cleaning fluid supply 166, such as a hydrogen peroxide tank mounted on the filter pack 160. A main cleaning fluid supply line 370 leads from the cleaning fluid supply 166 and branches into multiple module cleaning fluid supply lines 372, 374, 376, with each module supply line leading to a single module 104, 106, 108. The main cleaning fluid supply line 370 may branch by feeding into a manifold with multiple exits or it may branch by simply using “T” fittings or other branching pipe fittings. Each illustrated module supply line 372, 374, 376 includes a respective module cleaning fluid supply valve 380, 382, 384. The main cleaning fluid supply line 370 also includes a main cleaning fluid shut-off valve 390. Each illustrated module cleaning fluid supply line 372, 374, 376 feeds into a corresponding module hydrogen supply line 312, 314, 316.

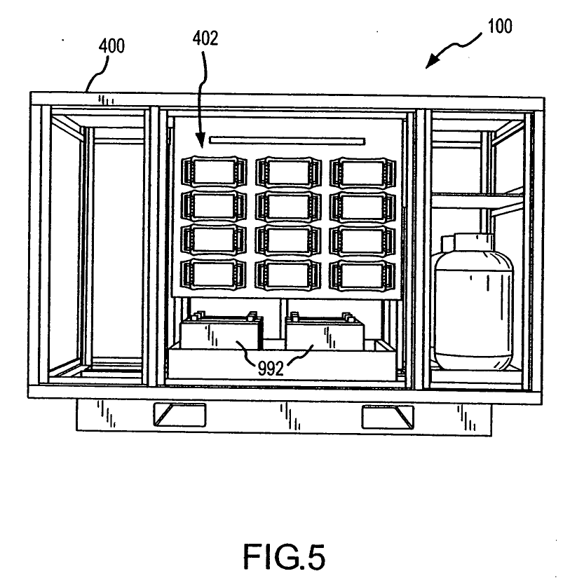

Three modules 104, 106, 108 are shown in FIG. 1. However the number of modules can vary depending on the desired electric power output of the fuel cell system 100. For example, as shown in FIG. 5, a frame 400 supports a fuel cell system 100 that includes a set 402 of fuel cell modules including four rows of three modules. The frame 400 can be constructed of any material that is sufficiently rigid, strong, and durable to support the fuel cell system 100.

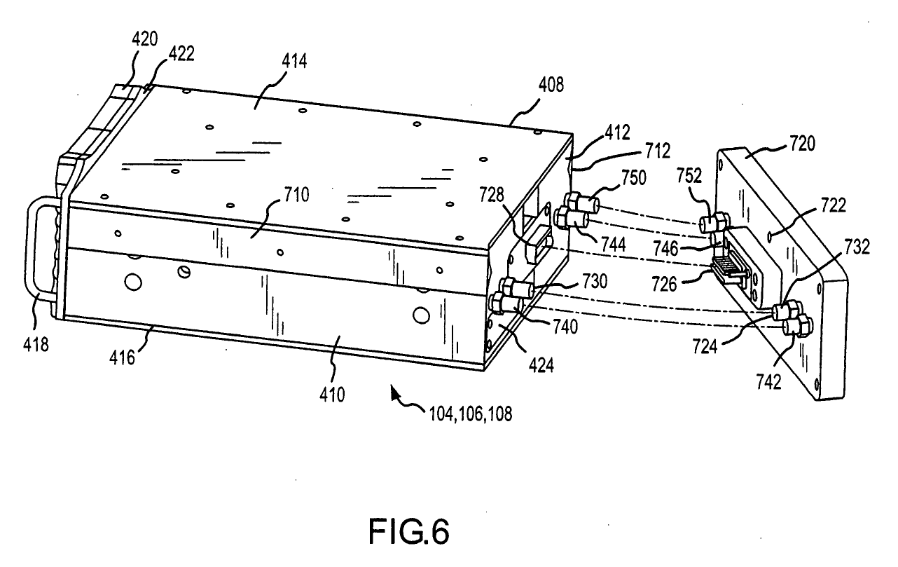

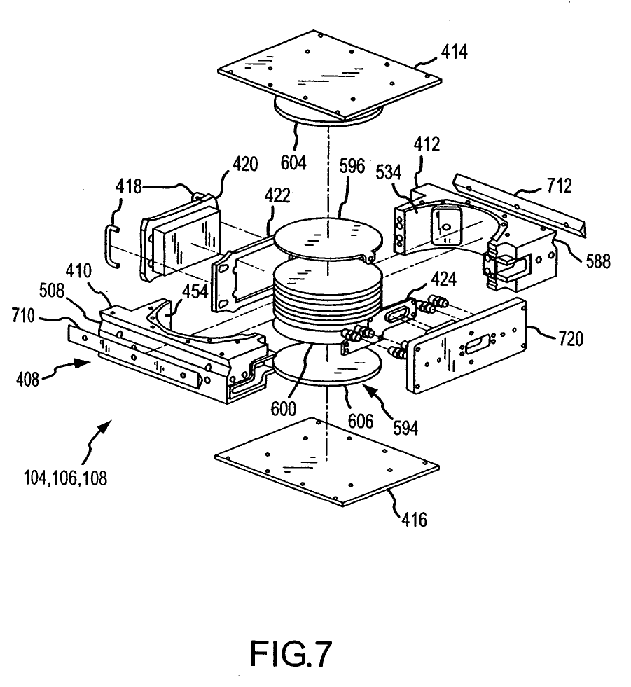

Referring to FIGS. 6-7, a module (e.g., modules 104, 106, 108) is shown along with additional related components of the fuel cell system 100. Each module 104, 106, 108 includes a housing 408. The housing 408 includes a right block or right member 410 (on the right when looking at the front of the housing 408), a left block or left member 412, a top lid 414 and a bottom lid 416. Each of these members is made of a rigid material that is easily machined or molded. In one embodiment the right block 410, the left block 412, the top lid 414 and the bottom lid 416 are all aluminum. Each module 104, 106, 108 also includes a pair of handles 418, a forward-facing user interface screen 420 secured to a face plate 422, and a rear cover 424. The face plate 422 is made of a rigid material that is easily machined or molded, such as aluminum. The user interface screen 420 may display, among other things, the output voltage, current, and power from the module 104, 106, 108. The rear cover 424 is typically made of an inexpensive rigid material, such as the polymer material sold under the name Delron by Dupont.

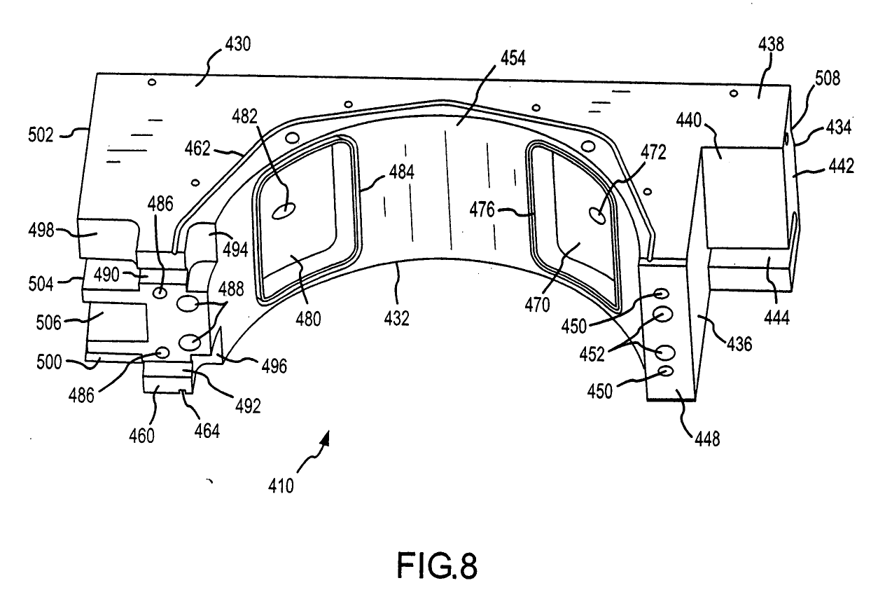

Referring to FIGS. 8-9, the right block 410 has a horizontal top planar surface 430 and an opposing horizontal bottom planar surface 432. The block also includes a vertical right side surface 434. A main front face 436 of the right block 410 is also vertical and is perpendicular to the right side surface 434. A face plate support 438 extends forward from the right side of the front face 436 so that the right side surface 434 continues along the face plate support 438. The face plate support 438 has a left-facing surface 440 opposite the right side surface 434, and a forward-facing face plate surface 442 extending between the left-facing surface 440 and the right side surface 434. A front wiring channel 444 extends into the face plate support 438 from the left-facing surface 440 and communicates with a screen wiring hole 446 that extends rearward through the right block 410.

A left-facing front contact surface 448 extends rearward from a left side of the main front face 436. A pair of front dowel or pin holes 450, sized to receive dowels or pins (not shown), extend from the front contact surface 448 into the right block 410. A pair of front screw holes 452 also extend from the front contact surface 448 through the right block 410. The front screw holes 452 in the illustrated embodiment are counter bored such that they have a larger diameter on the right side than the left side.

A semi-circular vertical clamping surface 454 extends to the right from the front contact surface 448 and curves until it extends back to the left and meets a rear contact surface 460 that is coplanar with the front contact surface 448. A top O-ring channel 462 in the top surface 430 extends around the clamping surface 454 from the front contact surface 448 to the rear contact surface 460 and receives a right half of a top O-ring (not shown). Similarly, a bottom O-ring channel 464 in the bottom surface 432 extends around the clamping surface 454 from the front contact surface 448 to the rear contact surface 460 and receives a right half of a bottom O-ring (not shown).

An air exhaust manifold or cavity 470 extends diagonally forward and to the right into the right block 410 from the clamping surface 454. An air exhaust conduit 472 extends from a central location in the manifold 470 to the right and then to the rear through the right block 410. An air exhaust port 474 (FIG. 9) extends from the right side surface 434 into the right block 410 and meets the air exhaust conduit 472. The air exhaust port 474 is formed by a mill during formation of the air exhaust conduit 472, and may be plugged to channel air exhaust through the air exhaust conduit 472. An air exhaust sealing channel 476 in the clamping surface 454 circumscribes the air exhaust manifold 470 and receives a sealant such as silicone to fluidly seal the air exhaust manifold 470.

Similarly, a hydrogen supply manifold or cavity 480 extends diagonally rearward and to the right into the right block 410 from the clamping surface 454. A hydrogen supply conduit 482 extends rearward through the right block 410 from a central location in the manifold 480. A hydrogen supply sealing channel 484 in the clamping surface 454 circumscribes the hydrogen supply manifold 480 and receives a sealant such as silicone to fluidly seal the hydrogen supply manifold 470.

A pair of rear dowel or pin holes 486, sized to receive dowels or pins (not shown), extend from the rear contact surface 460 into the right block 410. A pair of rear screw holes 488 also extend from the rear contact surface 460 into the right block 410. In the illustrated embodiment, the rear screw holes 488 are counter bored such that they have a larger diameter on the right side than the left side.

A top semicircular electrical line channel 490 and a bottom semicircular electrical line channel 492 extend axially rearward along the rear contact surface 460. Top and bottom front electrical line access cavities 494, 496, respectively, extend into the right block 410 where the rear contact surface 460 meets the clamping surface 454. Similarly, top and bottom rear electrical access cavities 498, 500, respectively, extend into the right block 410 from the left rear corner of the right block 410.

A vertical main rear face 502 of the right block 510 extends to the left from the right side surface 434, and a vertical rear cover mounting surface 504 is forwardly inset into the right block 410 from the main rear face 502. The rear cover mounting surface 504 extends around the top, bottom, and right sides of a rear wiring channel 506 that opens rearward and to the left and connects with the screen wiring hole 446.

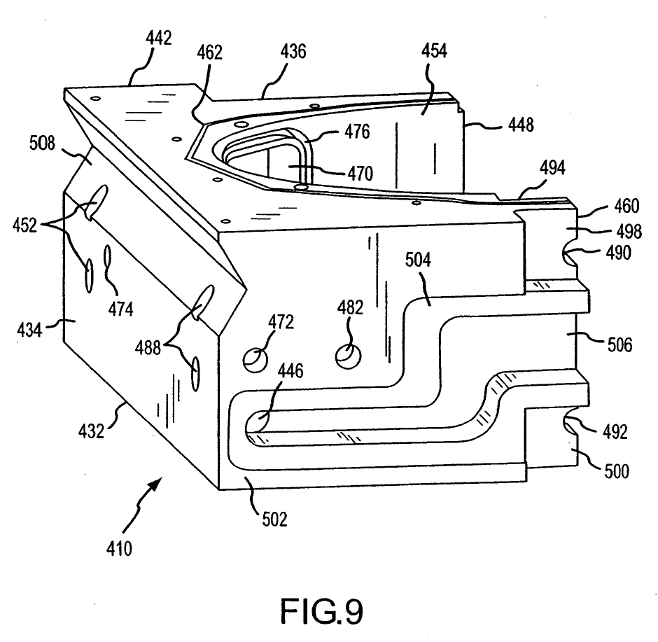

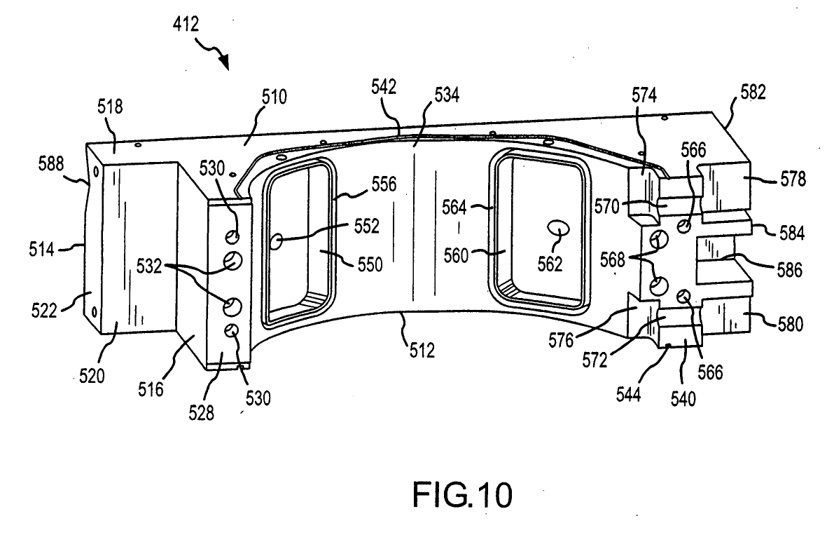

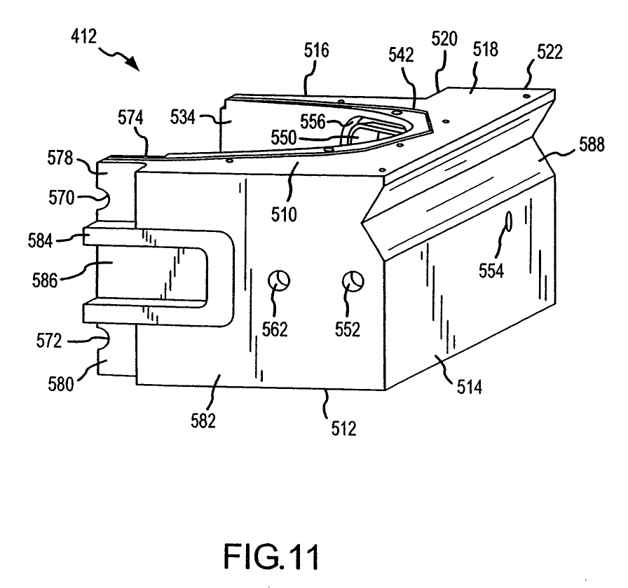

Referring to FIGS. 10-11, the left block 412 is designed to mate with the right block 410 just described. The left block 412 has a horizontal top planar surface 510 and an opposing horizontal bottom planar surface 512. The left block 412 also includes a vertical left side surface 514. A vertical main front face 516 of the left block 412 is perpendicular to the left side surface 514. A face plate support 518 extends forward from the left side of the front face 516 so that the left side surface 514 continues along the face plate support 518. The face plate support 518 has a right-facing surface 520 opposite the left side surface 514 and a forward facing face plate mounting surface 522 extending between the right-facing surface 520 and the left side surface 514.

A right-facing front contact surface 528 extends rearward from a right side of the main front face 516. A pair of front dowel or pin holes 530, sized to receive dowels or pins (not shown), extend from the front contact surface 528 into the left block 412. The dowel holes 450 of the right block 410 align with the dowel holes 530 of the left block 412 (FIGS. 8-9) and receive dowels or pins (not shown) that extend into corresponding dowel holes 450, 530 in the right and left blocks 410, 412.

A pair of front screw holes 532 also extend from the front contact surface 528 into the left block 412. The front screw holes 532 are threaded so that screws extending through the front screw holes 452 in the right block 410 (see FIGS. 8-9) engage the threads in the front screw holes 532 in the left block 412 to secure the two blocks together with the front contact surfaces 448, 528 of the blocks 410, 412 aligned and abutting each other.

A semi-circular vertical clamping surface 534 extends to the left from the front contact surface 528 and curves until it extends back to the right and meets a rear contact surface 540 that is coplanar with the front contact surface 528. A top O-ring channel 542 in the top surface 510 extends around the clamping surface 534 from the front contact surface 528 to the rear contact surface 540. Similarly, a bottom O-ring channel 544 in the bottom surface 512 also extends around the clamping surface 534 from the front contact surface 528 to the rear contact surface 540. The top and bottom O-ring channels 542, 544 receive the left halves of the respective top and bottom O-rings discussed above.

A hydrogen exhaust manifold or cavity 550 extends diagonally forward and to the right into the left block 412 from the clamping surface 534. A hydrogen exhaust conduit 552 extends from a central location in the manifold 550 to the left and then to the rear through the left block 412. A hydrogen exhaust port 554 extends from the left side surface 514 into the left block 412 and meets the hydrogen exhaust conduit 552. The hydrogen exhaust port 474 is formed as a byproduct of the milling process used to create the hydrogen exhaust conduit 552 and is generally plugged. A hydrogen exhaust sealing channel 556 in the clamping surface 534 circumscribes the hydrogen exhaust manifold 550 and receives a sealant such as silicone to fluidly seal the hydrogen exhaust manifold 550.

Similarly, an air supply manifold or cavity 560 extends diagonally rearward and to the left into the left block 412 from the clamping surface 534. An air supply conduit 562 extends rearward through the left block 412 from a central location in the manifold 560. An air supply sealing channel 564 in the clamping surface 534 circumscribes the air supply manifold 560 and receives a sealant such as silicone to fluidly seal the air supply manifold 560.

A pair of rear dowel or pin holes 566 extend from the rear contact surface 540 into the left block 412. The dowel or pin holes 566 receive respective dowels or pins that also extend into the rear dowel pin holes 486 of the right block 410 (see FIGS. 8-9). A pair of rear screw holes 568 also extend from the rear contact surface 540 into the left block 412. The rear screw holes 568 are threaded so that screws extending through the rear screw holes 488 in the right block 410 engage the threads in the rear screw holes 568 in the left block 412 to secure the two blocks together with the rear contact surfaces 460, 540 of the blocks 410, 412 aligned and abutting each other.

A top semicircular electrical line channel 570 and a bottom semicircular electrical line channel 572 extend axially rearward along the rear contact surface 540. The top and bottom electrical line channels 570, 572 align with the respective top and bottom electrical line channels 490, 492 of the right block 410 (see FIGS. 8-9) to allow electrical lines to pass between the blocks 410, 412. Top and bottom front electrical line access cavities 574, 576, respectively, extend into the left block 412 where the rear contact surface 540 meets the clamping surface 534. Similarly, top and bottom rear electrical access cavities 578, 580, respectively, extend into the left block 412 from the right rear corner of the left block 412.

A vertical main rear face 582 of the left block 412 extends to the right from the left side surface 514, and a vertical rear cover mounting surface 584 is forwardly inset into the left block 412 from the main rear face 582. The rear cover mounting surface 584 extends around the top, bottom, and right sides of a rear wiring channel 586 that opens rearward and to the right, connecting with the rear wiring channel 506 in the left block 412.

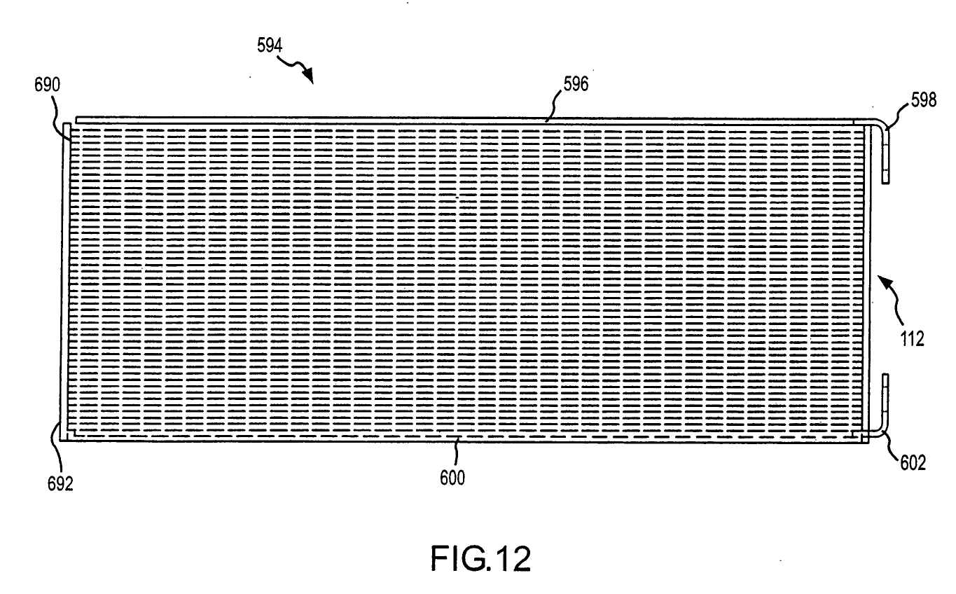

Each module 104, 106, 108 also includes a fuel cell stack 594 shown in FIG. 12 and depicted in exploded view in FIG. 7. Each fuel cell stack 594 is generally cylindrical, although it could be other shapes. Each stack 594 includes a top plate 596 having a top connection bracket 598, and an opposing bottom plate 600 having a bottom connection bracket 602. The top and bottom plates 596, 600 preferably are good electrical conducting materials. In one embodiment, the top and bottom plates 596, 600 are copper or gold.

Referring to FIGS. 7, 8, 10, and 12, the fuel cell stack 594 is clamped between the clamping surface 454 in the right block 410 and the clamping surface 534 in the left block 412. The top connection bracket 598 is located within the top front electrical line access cavities 494, 574, and a conducting connector extending through the top electrical line channels 490, 570 provides an electrical connection to the top connection bracket 598, and thus to the negative pole of the fuel cell stack 594. Similarly, the bottom connection bracket 602 is located within the bottom front electrical line access cavities 496, 576, and a conducting connector extending through the bottom electrical line channels 492, 572 provides an electrical connection to the bottom connection bracket 602, and thus to the positive pole of the fuel cell stack 594. In some embodiments, the conducting connectors each include a standard, quick-release electrical connection, such as the connection commonly known as a banana jack.

Each module 104, 106, 108 may also include a top insulating disc 604 above the top plate 596 and a bottom insulating disc 606 below the bottom plate 600 (FIG. 7). The insulating discs 604, 606 are made of an insulating material such as an elastomer or rubber.

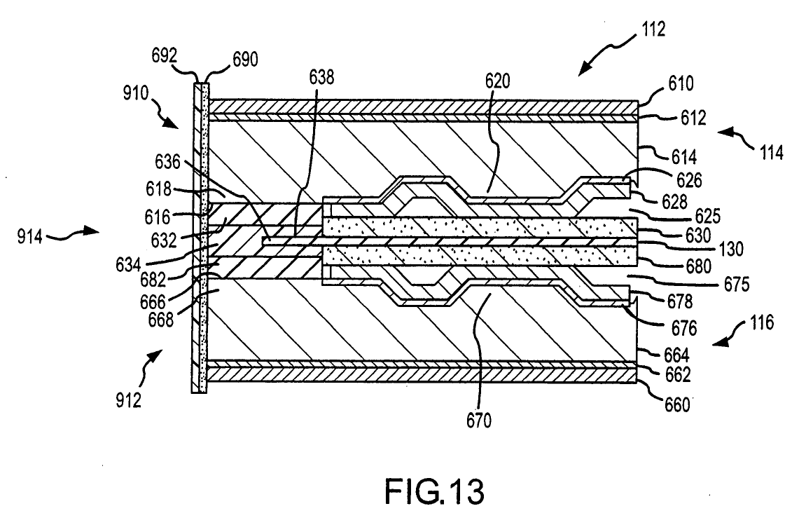

Between the top disc 596 and the bottom disc 600, each fuel cell stack includes multiple plate-shaped fuel cells 112 that are preferably round, or disc-shaped. The fuel cells 112 are preferably stacked in series with the cathode side 116 of each fuel cell 112 abutting the anode side 114 of an adjacent fuel cell 112, and the anode side 114 of each fuel cell 112 abutting the cathode side 116 of an adjacent fuel cell 112. As illustrated in FIGS. 12-13, a top fuel cell 112 has an anode side 114 that abuts the top plate 596, and a bottom fuel cell 112 has a cathode side 116 that abuts the bottom plate 600. Alternatively, when the fuel cells are stacked in this configuration, a single silicon substrate could be used as the top silicon layer of a first fuel cell and as the bottom silicon layer of a second fuel cell that is immediately above the first fuel cell. In this embodiment, the contact layers and the contact binding layers between the first and second fuel cells could be eliminated.

FIG. 13 is a sectional view of the periphery of a fuel cell 112, depicting the layers in the fuel cell 112. Each of the layers is disc-shaped, although some layers preferably have larger diameters than others, as discussed below.

Beginning on the top or anode side 114, the top layer of the fuel cell 112 is a contact layer 610, which is preferably a good conductor that can be easily attached to other electrical components by soldering. In one embodiment the top contact layer 610 is a 3000 Å-thick gold layer. Below the top contact layer 610 is a top contact binding layer 612 that is typically a material that binds well to the top contact layer 610 and to the next layer down, a top silicon layer 614. In one embodiment, the top contact binding layer 612 comprises titanium.

The top silicon layer 614 is inexpensively and readily manufactured on a micro scale, and is a good conductor of electricity. While this layer 614 could be a material other than silicon, it is preferably a silicon wafer 614 because such wafers are readily manufactured with micro geometries and they can be good electric conductors when doped. More preferably, the layer 614 is a boron doped wafer with 110 degree orientation having a resistance of from about 0.01 ohms to about 0.02 ohms. This resistance is as low as the resistance in typical carbon layers used in some fuel cell applications. However, the silicon wafer 614 is more easily manufactured to have the micro geometries discussed below.

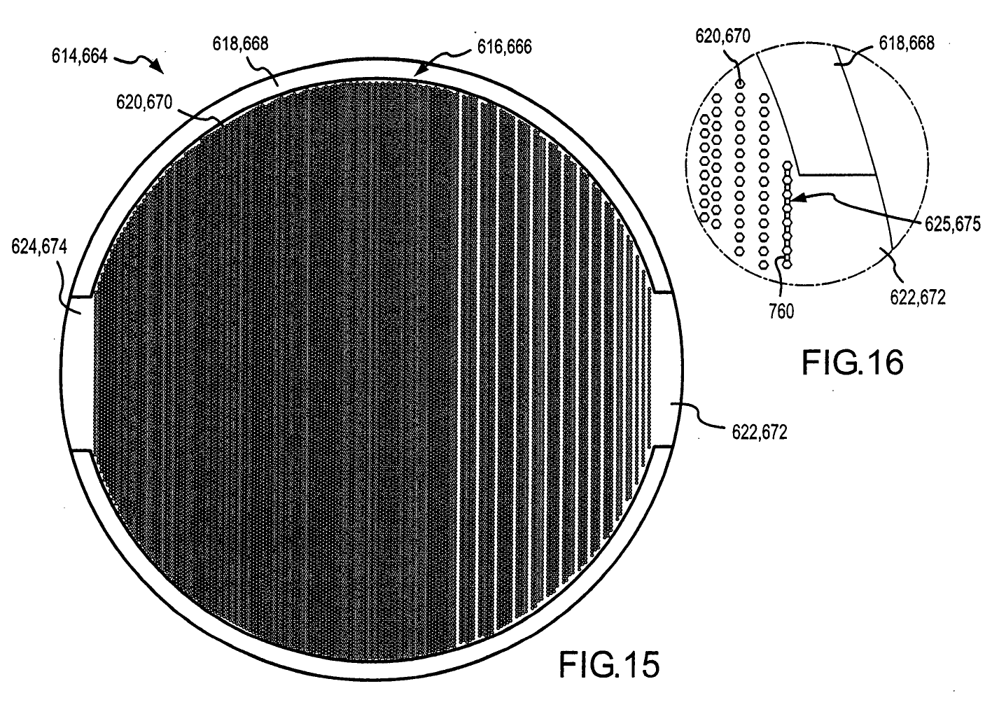

A bottom face 616 of the top silicon layer 614 is non-planar in the illustrated embodiment. The non-planar features of the bottom face 616 create flow channels for the hydrogen gas to flow through the anode side 114 of the fuel cell 112. The non-planar features create obstacles to the flow of hydrogen gas through the fuel cell 112, that disrupt and slow the hydrogen gas flow. The non-planar features also increase the surface area of the bottom face 616. In one embodiment, the bottom face 616 includes an outer lip 618 and downwardly-extending protrusions or pillars 620, the outer lip 618 surrounding the pillars 620 (see FIG. 15). The pillars 620 obstruct the flow of hydrogen, requiring the hydrogen to flow around the pillars 620. In other words, the pillars 620 split the flow of hydrogen into channels 625, and the flow is again split with each succeeding row of pillars.

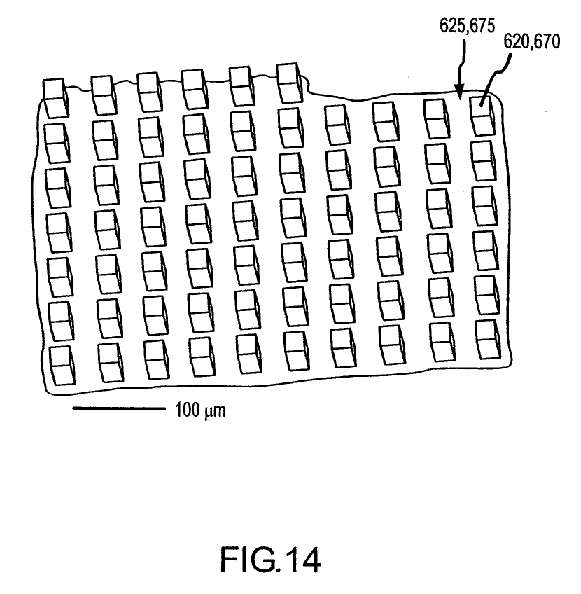

Referring to FIG. 14, the pillars 620 may be arranged in a pattern to optimize the flow characteristics of the hydrogen flowing in the channels 625 around the pillars 620. While the pillars 620 depicted in FIG. 14 have square cross-sections, the pillars 620 may have other geometries, such as the hexagonal cross sections shown in FIGS. 15-16. Hexagonal cross sections are most typical because they can be arranged in honeycomb configuration that effectively slows and mixes or diffuses the hydrogen flow. Each silicon layer 614 includes multiple pillars 620, typically from about 40,000 to about 70,000 pillars 620, as determined mathematically or from computer models, and even more typically from about 50,000 to about 60,000 pillars 620.

Referring to FIG. 15, the downwardly-extending outer lip 618 of the top silicon layer 614 extends around the periphery of the bottom face 616, but is interrupted by an inlet gap or window 622 and an outlet gap or window 624. In one embodiment, the inlet gap 622 and the outlet gap 624 are each about 350 microns tall and about two inches wide. The hexagonal pillars 620 are generally arranged in a honeycomb pattern, with flow channels 625 being defined between the hexagonal pillars 620. The pattern of pillars 620 is not as dense near the inlet gap 622, so that sufficient flow is allowed to enter the area of the pillars 620, but the flow is gradually slowed and interspersed within the pattern of pillars 620.

In one embodiment, wherein the top silicon layer 614 is an eight-inch diameter silicon wafer, the outer ring is 0.25 inch wide (between the outer radius and the inner radius) and 350 microns tall. Each pillar 620 is about 350 microns from point-to-point on each hexagon and about 350 microns tall, with flow channels between adjacent pillars being about 0.0156 inch wide. Such an arrangement approximately doubles the exposed surface area of bottom face 616 relative to a planar bottom face, and it slows the flow of gas through the maze of pillars 620, allowing the reactions with the gas to take place as the gas passes through the flow channels 625. However, many other dimensions and geometric arrangements of pillars 620, such as the rectangular arrangement shown in FIG. 14, may be used. Additionally, flow obstacles other than pillars 620 may be used to increase the surface area of the bottom face 616 and slow the flow of gases. For example, ridges or walls may be used, rather than pillars 620.

Referring back to FIG. 13, below the top silicon layer 614 is a top catalyst binding layer 626 that is coated on the bottom face 616 of the top silicon layer 614. The binding layer 626 has good conductivity and can readily bond to silicon and to joined platinum and tin oxide (SnO). In one embodiment, the top catalyst binding layer 626 is platinum salicide (PtSi). Below the top catalyst binding layer 626 is a top catalyst layer 628 that is coated on the top catalyst binding layer 626. The top catalyst layer 628 acts as a catalyst to strip electrons from hydrogen molecules, producing electrons and protons. Additionally, the top catalyst layer 628 may include a material such as tin oxide to prevent contamination of the catalyst material by substances such as carbon monoxide gas that may enter the fuel cell 112 from the reactor 180. In one embodiment, the top catalyst layer 628 is joined platinum and tin oxide (SnO), most preferably about ninety percent platinum and about ten percent tin oxide. The platinum acts as a catalyst for splitting hydrogen molecules, and the tin oxide catalyzes a reaction of carbon monoxide that yields carbon dioxide. Alternatively, the top catalyst layer 628 may be joined platinum and chromium trioxide. The top catalyst layer 628 and the top catalyst binding layer 626 are concentric with the top silicon layer 614 in the illustrated embodiment, having diameters less than the top silicon layer 614, leaving an outer ring of the top silicon layer that is not coated with the top catalyst layer 628 or the top catalyst binding layer 626. The top catalyst layer 628 and the top catalyst binding layer 626 are coated on the pillars 620 in addition to the remainder of the bottom face 616. Thus, the surface area of the top catalyst layer 628 that is exposed to flowing hydrogen typically is greater than if the bottom face 616 were merely a planar surface.

Below the top catalyst layer 628 is a top proton absorbing layer 630. The top proton absorbing layer 630 absorbs protons and allows them to pass through the proton absorbing layer 630 from or to the membrane 130—i.e., the proton absorbing layer allows protons to be transported from the three phase boundary where the reactant gas is ionized to membrane 130 and in that fashion transports positive charge. In one embodiment, the top proton absorbing layer 630 is carbon nanofoam. The top proton absorbing layer 630 preferably has a diameter similar to the diameters of the top catalyst binding layer 626 and the top catalyst layer 628.

Below the outer ring of the top silicon layer is a top oxide ring 632 extending around the top catalyst layer 628 and the top proton absorbing layer 630. The top proton absorbing layer 630 typically abuts the top oxide layer, but there is typically a gap between the top catalyst layer 628 and the top oxide ring 632. The top oxide ring 632 is an insulating material such as silicon dioxide (SiO₂). Below the top oxide ring 632 is a gasket ring 634 that should be a good insulator that can bind to the top oxide ring 632 as well as to the membrane 130. In one embodiment, the gasket ring 634 is made of silicone. The membrane 130 is located below the top proton absorbing layer 630 and has a larger diameter than the proton absorbing layer 630 so that an outer ring 636 of the membrane extends into a recess 638 in the gasket ring 634.

The layers below the membrane 130 and the silicone gasket ring 634 (i.e., on the cathode side 116) in one embodiment are a mirror image or repeat of the layers described above on the anode side 114. This simplifies the manufacturing process. Thus, the cathode side 116 includes a bottom contact layer 660, a bottom contact binding layer 662, and a bottom silicon layer 664. The bottom silicon layer 664 also includes a top face 666 having an outer lip 668 surrounding a maze of pillars 670. The outer lip 668 is interrupted by an inlet gap 672 and an outlet gap 674, and the pillars 670 define flow channels 675 (see FIGS. 15-16). The cathode side 116 also includes a bottom catalyst binding layer 676, a bottom catalyst layer 678, a bottom proton absorbing layer 680, and a bottom oxide ring 682.

While the cathode side 116 is a mirror image of the anode side 114, the cathode side 116 is rotated 90° relative to the anode side 114. Thus, the inlet gap 622 on the anode side 114 is shifted 90° relative to the inlet gap 672 on the cathode side 116. When the fuel cells 112 are placed in a fuel cell stack 594, the fuel cells are rotated so that like parts of the fuel cells 112 are aligned (the anode side inlet gaps 622 are all aligned, the cathode side inlet gaps 672 are all aligned, etc.).

Referring to FIGS. 12-13, within the fuel cell stack 594, a bottom-most fuel cell 112 has a bottom contact layer 660 that abuts the bottom plate 600 and a top contact layer 610 abuts the bottom contact layer 660 of the next higher fuel cell 112. The top contact layer 610 of the next higher fuel cell 112 abuts the bottom contact layer 660 of the third fuel cell 112 from the bottom, and so forth. The top-most fuel cell 112 has a top contact layer 610 that abuts the top plate 596. Thus, the stack 594 is arranged in series so that the overall stack has a positive (or cathode) pole at the bottom plate 600 and a negative (or anode) pole at the top plate 596. Alternatively, the stack 594 may be arranged in parallel, or it may be arranged with some combination of series and parallel connections between fuel cells 112. The abutting contact layers 610, 660 may be effectively coupled together, for example adjacent fuel cells may be soldered together. The top and bottom plates 596, 600 are not soldered to the adjacent contact layers 610, 660 in some embodiments, but they could be if desired.

The illustrated fuel cell stack 594 also includes an adhesion layer 690 that extends about the circumference of the fuel cell stack 594, binding the fuel cells 112 together. In one embodiment, the adhesion layer 690 is an epoxy resin. Additionally, the fuel cell stack 594 includes a sealing layer 692, such as silicone, surrounding the adhesion layer 690 to substantially prevent fluid leakage from the fuel cells 112.

Referring to FIGS. 7-12, the fuel cell stack 594 is clamped between the clamping surfaces 454, 534 of each module 104, 106, 108 with the vertical clamping surfaces 454, 534 being perpendicular to the plate-shaped fuel cells 112. The fuel cell stack 594 is rotationally oriented so that the anode side inlet gaps 622 (FIG. 15) open into the hydrogen supply manifold 480 and the diametrically opposed anode side outlet gaps 624 (FIG. 15) open into the hydrogen exhaust manifold 550. Likewise, the cathode side inlet gaps 622 (FIG. 15) open into the air supply manifold 560 and the cathode side outlet gaps 674 (FIG. 15) open into the air exhaust manifold 470. The fuel cell stack 594 may include indicia, such as a notch or other locating mark, at a specific radial location to aid in rotationally orienting the stack 594 and in orienting fuel cells 112 within the stack 594.

The stack sealing layer 692 of the fuel cell stack 594 abuts the clamping surfaces 454, 534, and the sealant within the sealing channels 476, 484, 556, 564 abuts housing 408 and the fuel cell stack 594 to create seals around each of the manifolds 470, 480, 550, 560 in the housing 408 around the inlet gaps 622, 672 and outlet gaps 624, 674 (FIG. 15) that open into corresponding manifolds.

Referring to FIGS. 6-11, the top lid 414 is secured to the top surfaces 430, 510 of the blocks 410, 412, such as with threaded fasteners. Likewise, the bottom lid 416 is secured to the bottom surfaces 432, 512 of the blocks 410, 412, preferably by threaded fasteners. The face plate 422 is secured to the face plate surfaces 442, 522 of the face plate supports 438, 518, by threaded fasteners. The handles 418 and the user interface screen 420 are both mounted to the front of the face plate 422. The rear cover 424 is mounted on the rear cover mounting surfaces 504, 584 to cover and contain wiring in the rear wiring channels 506, 586.

Referring still to FIGS. 6-7, the frame 400 (FIG. 5) supports a right guide bar 710 (FIG. 6) that mates with the “V”-shaped channel 508 in the right block 410 and a left guide bar 712 that mates with the “V”-shaped channel 588 in the left block 412 of each module 104, 106, 108. The frame 400 (FIG. 5) also supports a backing plate 720 for each module 104, 106, 108. The backing plate 720 is a generally rectangular plate that is located behind and parallel to the main rear faces 502, 582 (FIG. 6) of the blocks 410, 412. The backing plate 720 includes a top electrical line hole 722 that is aligned with the top electrical line channels 490, 570 in the blocks 410, 412. An electrical connector (not shown) mounted in the top electrical line hole 722 mates with an electrical connector mounted in the top electrical line channels 490, 570 in the blocks 410, 412 (FIGS. 9 & 11). The backing plate 720 also includes a bottom electrical line hole 724 that is aligned with the bottom electrical line channels 492, 572 (FIGS. 9 & 11). In one embodiment, the top and bottom electrical line connectors are banana jack connectors.

A male signal line fitting 726 is mounted on each backing plate 720. The male signal line fitting 726 mates with a female signal line fitting 728 mounted to the rear cover 424. The female signal line fitting 728 is connected to the controls and sensors of the module 104, 106, 108, and to the user interface screen 420. More specifically, wires extend from the female signal line fitting 728 through the rear wiring channels 506, 586, through the wiring hole 446, through the front wiring channel 444 (see FIG. 8-11) and to the user interface screen 420. The male signal line fitting 726 is connected to the controller of the fuel cell system 100, as discussed below.

A male hydrogen supply fitting 730 is connected to the hydrogen supply conduit 482 (FIG. 9), and a mating female hydrogen supply fitting 732 is mounted on the backing plate 720. Likewise a male air exhaust fitting 740 is connected to the air exhaust conduit 472 (FIG. 9), and a mating female air exhaust fitting 742 is mounted on the backing plate 720. A male air supply fitting 744 is connected to the air supply conduit 562 (FIG. 11), and a mating female air supply fitting 746 is mounted on the backing plate 720. Finally, a male hydrogen exhaust fitting 750 is connected to the hydrogen exhaust conduit 552 (FIG. 11), and a mating female hydrogen exhaust fitting 752 is mounted on the backing plate 720. All the supply and exhaust fittings are typically quick-release fittings that do not require manual manipulation when mating or releasing.

Referring still to FIGS. 6-7, each module 104, 106, 108 can be easily connected to the system 100 by sliding the module 104, 106, 108 along the guide bars 710, 712. As the module 104, 106, 108 is slid rearward along the guide bars 710, 712, the corresponding electrical and fluid fittings of the module 104, 106, 108 and the backing plate 720 align and connect. Besides the guide bars 710, 712, each module 104, 106, 108 is preferably supported from beneath by the frame 400 while the module is connected to the system 100. The module 104, 106, 108 can be disconnected from the system 100 by sliding the module 104, 106, 108 forward along the guide bars 710, 712.

Referring to FIGS. 1-2, Various controls, micromechanical devices, and microelectromechanical devices may be included within each fuel cell 112. For example, each fuel cell 112 may include sensors for temperature (such as platinum thermocouples), pressure, voltage, current, power, flow rate, concentration of relevant gases, or other relevant characteristics or properties of each fuel cell 112. Each fuel cell module 104, 106, 108 also may include a time sensor that tracks the time the module 104, 106, 108 has been active. As an example of possible micromechanical devices or microelectromechanical devices, sphincter valves 760 (FIG. 16) can be included in the flow channels 625, 675. Such valves can vary the flow to specific parts of the fuel cell 112. For example such valves can restrict flow in response to temperature increases in specific areas of the fuel cell 112, thereby decreasing the rate of reactions in those areas.

The controls for such micromechanical and microelectromechanical devices may be included internally within each fuel cell 112 or module 104, 106, 108. Alternatively, the devices could be controlled by a general control for the overall system 100. Additionally, the logic for utilizing data acquired by sensors within the fuel cells 112 can be processed and used internally within specific fuel cells 112 or modules 104, 106, 108. The data also can be transmitted through the signal line fittings 726, 728 (FIG. 6) to the overall controls of the system 100 and used in regulating the system 100. Additionally, the data can be transmitted to user interfaces within the modules 104, 106, 108, such as the user interface screen 420 (FIG. 7). It also can be transmitted through the signal line fittings 726, 728 to a user interface for the overall system 100. Such transmission can be internally within the system 100 or over a local or global computer network.

Additionally, various electrical and electronic components can be located within the modules 104, 106, 108. For example, an array of capacitors could be mounted on a silicon layer of a fuel cell 112. Alternatively, an additional silicon wafer having electrical and electronic components could be included in the fuel cell stack 594.

Referring to FIG. 1, the hydrogen exhaust conduit 552 (FIG. 10) from each module 104, 106, 108 is connected to a respective module hydrogen exhaust line 834, 836, 838 that has a respective module hydrogen exhaust valve 844, 846, 848. The module hydrogen exhaust lines 834, 836, 838 lead to a main hydrogen exhaust line 850. The main hydrogen exhaust line 850 also may be selectively connected to a hydrogen return line (not shown) that leads to the reactor 180. The hydrogen return line may be used if excess unreacted hydrogen passes through the fuel cells 112. However, as noted above, preferably the hydrogen flow is such that substantially all hydrogen is reacted within the modules 104, 106, 108.

Likewise, the air exhaust conduit 472 (FIG. 8) from each module 104, 106, 108 is connected to a respective module air exhaust line 864, 866, 868 that has a respective module air exhaust valve 874, 876, 878. The module air exhaust lines 864, 866, 868 lead to a main hydrogen exhaust line 880.

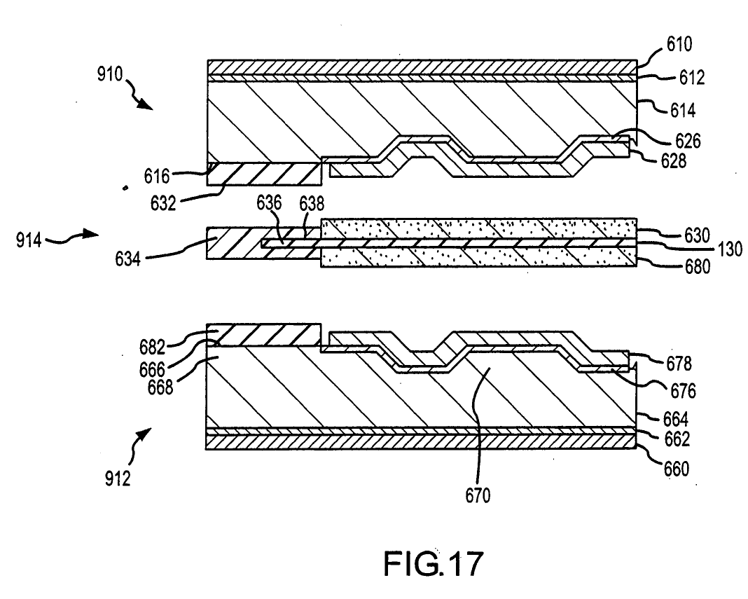

For the most part, manufacturing of the fuel cells 112 can take advantage of standard semiconductor processing techniques. This is a significant advantage because such manufacturing capability already exists on a large scale. While specific processes are described below, other standard semiconductor processes could also be used. Referring to FIG. 17, in general a top assembly 910 and a bottom assembly 912 are first formed. In one embodiment, these two assemblies are the same and are thus formed using the same manufacturing processes. The top assembly 910 and a bottom assembly 912 are then combined to sandwich a middle assembly 914 and form a fuel cell 112.

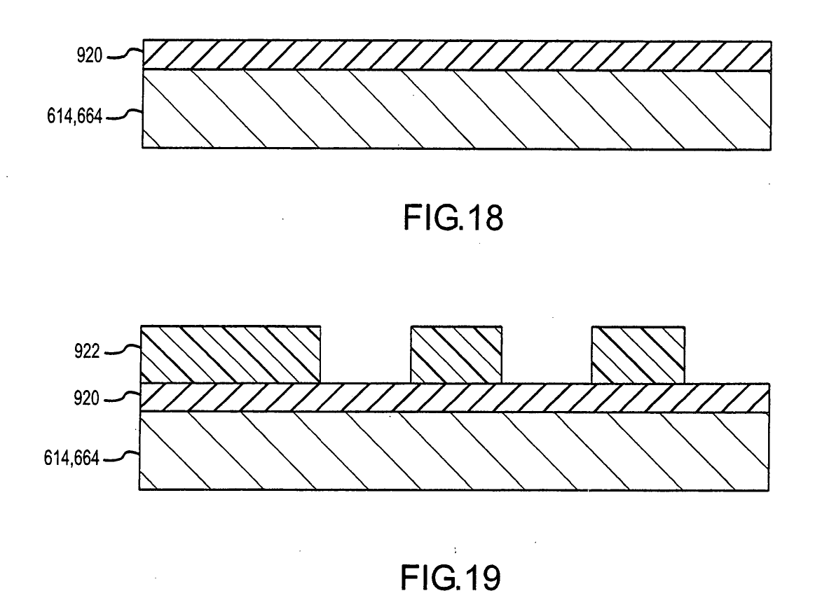

Referring to FIG. 18, in forming the top and bottom assemblies 910, 912, an oxide layer 920 is formed on the respective bottom and top faces 616, 666 of the silicon layers 614, 664. This can be done by exposing the face 616, 666 to substantially pure oxygen at about

Celsius. In one embodiment, the oxide layer 920 is thick enough to prevent electrons from circumventing the membrane 130, typically about 6000 Å thick. As will be described below, the outer ring of this oxide layer 920 will later become the respective oxide ring 632, 682 (FIG. 13).

Referring to FIG. 19, a trench pattern is then formed on the oxide layer 920 using lithography. More specifically, a photo resist material is spun onto the oxide layer 920 so that it covers the whole layer 920. Then, part of the resist is exposed and then developed, or etched away, leaving a resist pattern 922 that covers the areas where the outer lip 618, 668 and the pillars 620 will be (see FIG. 15).

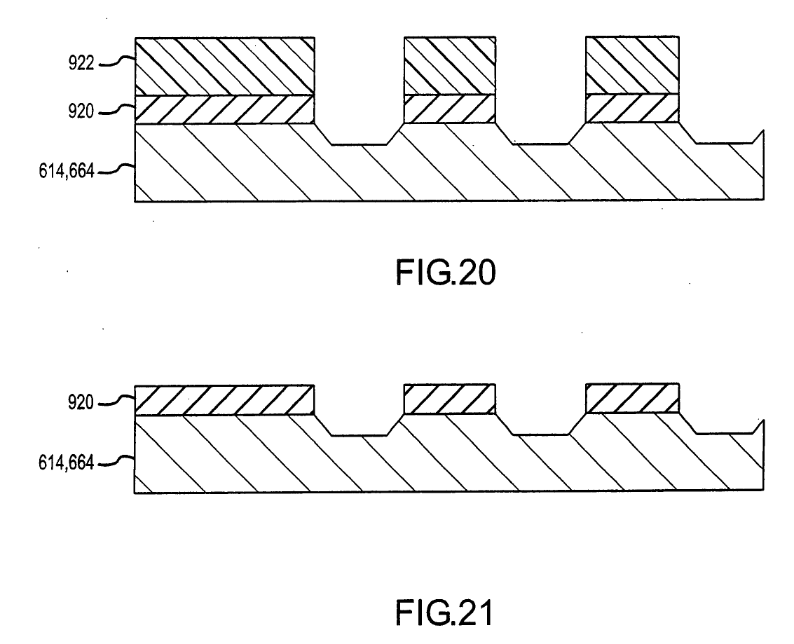

Referring to FIG. 20, a wet acid etch is used to remove the oxide layer 920 that is not protected by the resist pattern 922, and to trench the silicon layer 614, 664, forming the outlet gap 624, 674, the inlet gap 622, 672, and the flow channels 675 (see FIGS. 15-16).

Referring to FIG. 21, the resist pattern 922 from FIGS. 19-20 is then removed by an ash etch, i.e. by exposing it to heat. When exposed to the heat, the resist pattern 922 becomes ash that is easily removed. The temperature of this heating step should be high enough to burn off the resist pattern 922, but not high enough to substantially affect the properties of the silicon layer 614, 664 or the remaining oxide layer 920.

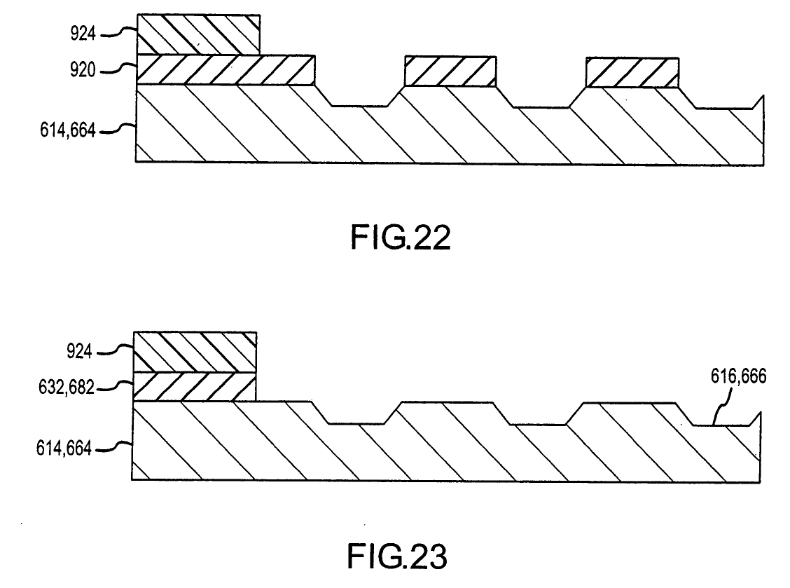

Referring to FIG. 22, a resist material is sprayed through a mask to form a resist ring 924 that covers the oxide ring 632, 682 (FIG. 13). Referring to FIG. 23, the remainder of the oxide layer 920 is removed with a caustic oxide etch, such as an etch using liquid NaOH, leaving the oxide ring 632, 682. The resist ring 924 is then removed from the oxide ring 632, 682 by an ash etch. A wet etch is then used to remove any oxide that may have formed during the ash etch and to prepare the non-planar face 616, 666 for receiving a sputter deposition.

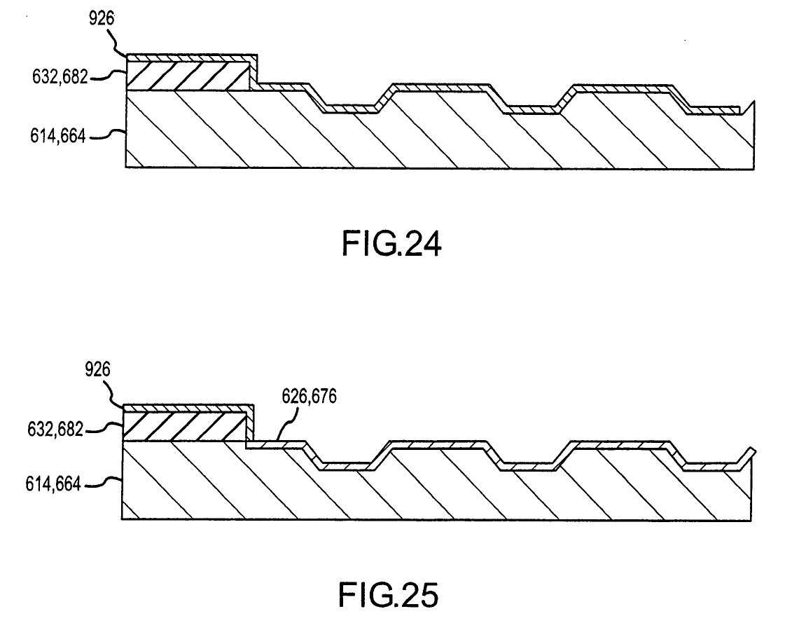

Referring to FIG. 24, a platinum layer 926 is then formed over the entire non-planar face 616, 666, including the oxide ring 632, 682, by sputter deposition. The platinum layer 926 is about 600 Å thick. Referring to FIG. 25, the platinum layer 926 is heated, allowing silicon to diffuse into the platinum to form the platinum salicide (PtSi) catalyst binding layer 626, 676, which is sufficiently thick to bind the catalyst layer 628, 678 to the silicon layer 614, 664. In one embodiment, the catalyst binding layer 626, 676 is about 1000 Å thick. The portion of the platinum layer 926 that covers the oxide ring 632, 682 does not form PtSi, i.e., remains unreacted, because it is not abutting the underlying silicon.

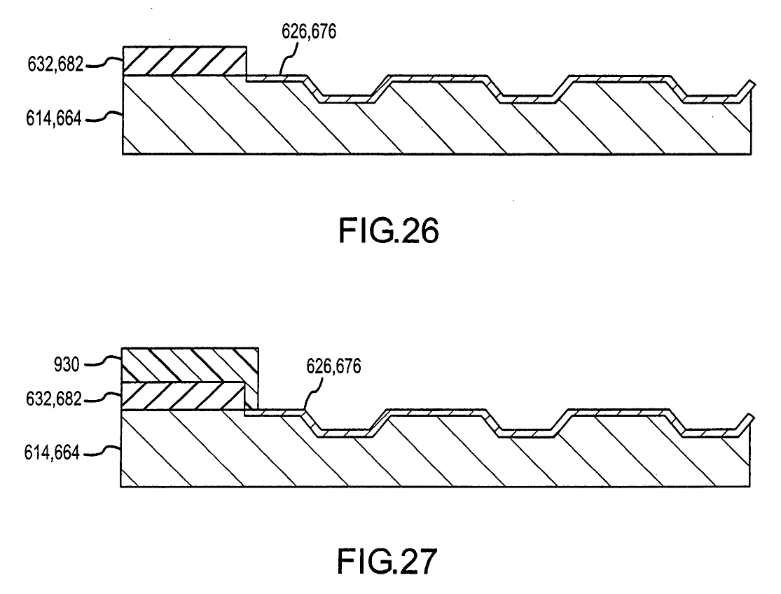

Referring to FIG. 26, the assembly undergoes a dilute aqua rega etch (rinsed with deionized water) at about 85° Celsius. Then a liquid etch removes the unreacted portion of the platinum layer 926.

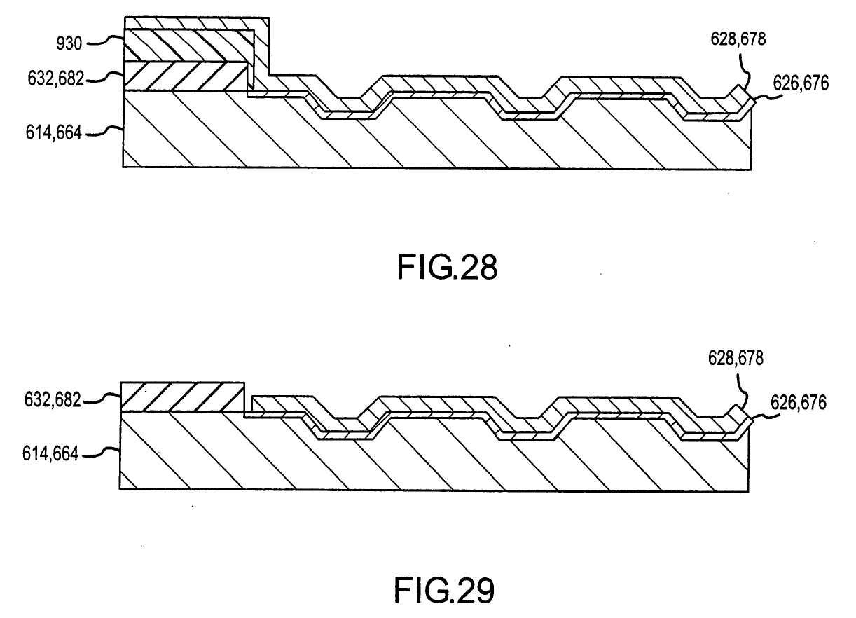

Referring to FIG. 27, a lift-off layer 930 is applied to the oxide ring 632, 682 by spraying through a mask. Referring to FIG. 28, the catalyst layer 628, 678 is applied using a reactive sputter deposition process. Specifically, a Pt—Cr sputter target is used in a reactive Ar—O₂ atmosphere to form Pt—CrO₃. In one embodiment, the catalyst layer 628, 678 is about ninety percent platinum and about ten percent CrO₃, and is sufficiently thick to include an effective amount of platinum catalyst to catalyze the reaction of Hydrogen to yield hydrogen ions. In one embodiment, the catalyst layer 628, 678 is about 5000 Å thick. Referring to FIG. 29, the lift-off layer 930 is then removed along with any Pt—CrO₃ that formed on the lift-off layer 930, leaving the exposed oxide ring 632, 682 and a gap between the catalyst layer 628, 678 and the oxide ring 632, 682. An etch may then be performed on the catalyst layer 628, 678 if it is too thick.

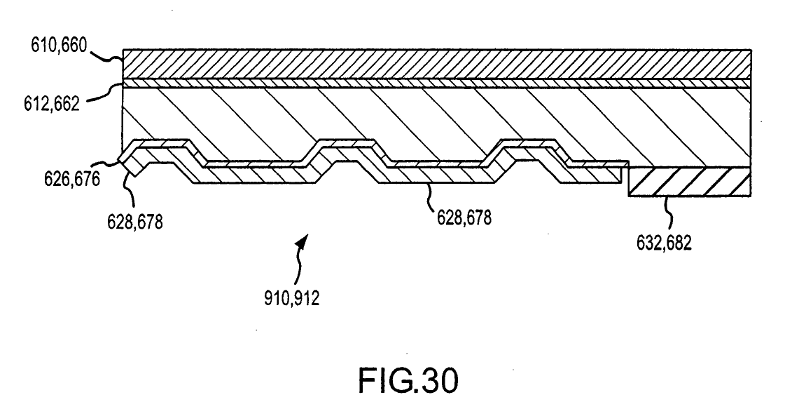

Referring to FIG. 30, the planar back face of the silicon layer 614, 664 is then dry etched using proton bombardment to prepare the back face for sputter deposition. The contact binding layer 612, 662 is applied using sputter deposition. The contact binding layer 612, 662 is thick enough to bind the silicon layer 614, 664 to the contact layer 610, 660. In one embodiment, the contact binding layer is about 600 Å thick. Then, the contact layer 610, 660 is applied to the contact binding layer 612, 662, completing the top or bottom assembly 910, 912, respectively. The contact layer 610, 660 is thick enough to provide a good contact surface and to be soldered to a contact layer of an adjacent fuel cell. In one embodiment, the contact layer 610, 660 is about 3000 Å thick.

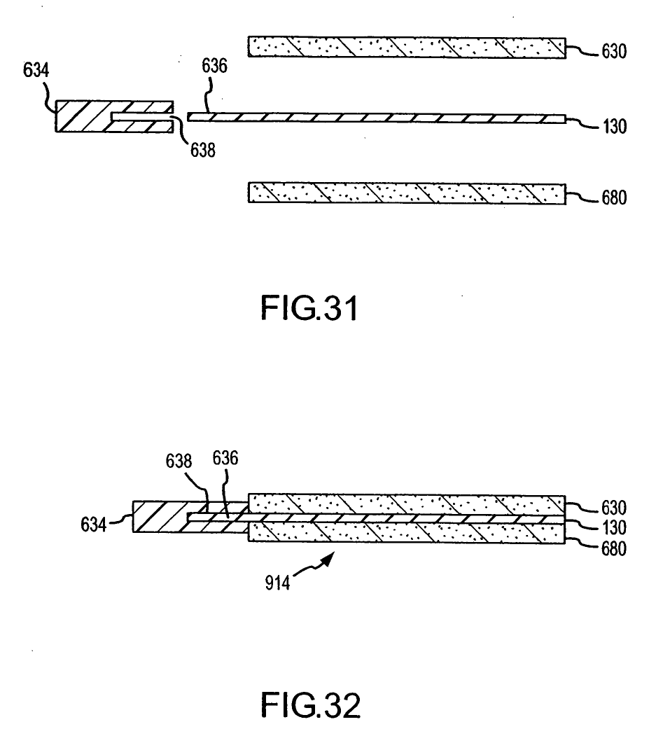

Referring to FIG. 31, in one embodiment, the membrane 130 is a sheet of the polymer material sold under the name Nafion 117 by Dupont, although it could be some other proton exchange membrane material. Each proton absorbing layer 630, 680 may be coated with liquid Nafion 117 material to promote adhesion to the membrane 130. The proton absorbing layers 630, 680 are assembled with the membrane 130 in a hot press and the silicone gasket ring 634 is applied to the outer ring 636 of the membrane 130 as shown in FIG. 32. The resulting middle assembly 914 is then cured at an elevated temperature of about 240° Fahrenheit for about one hour.

Referring to FIGS. 13 and 17, the top assembly 910, the bottom assembly 912, and the middle assembly 914 are then assembled in a hot press with the middle assembly 914 sandwiched between the top assembly 910 and the bottom assembly 912. The non-planar faces 616, 666 of the silicon layers 614, 664 face toward the middle assembly 914. The assemblies are cured at a temperature sufficient to bind the layers together, such as about 275° Fahrenheit for about one hour in one embodiment.

Referring to FIGS. 2, 12, and 13, a fuel cell stack 594 is formed by stacking multiple fuel cells 112 with top contact layers 610 abutting adjacent bottom contact layers 660. Abutting contact layers 610, 660 may be soldered together. The sides of the fuel cell stack 594 are then coated with an adhesive layer 690 and a sealing layer 692. Referring to FIGS. 7-12, the fuel cell stack 594 is clamped between the right block clamping surface 454 and the left block clamping surface 534 of a module 104, 106, 108 with the top connection bracket 598 in the top front electrical line access cavities 494, 574 and the bottom connection bracket 602 in the bottom front electrical line access cavities 496, 576.

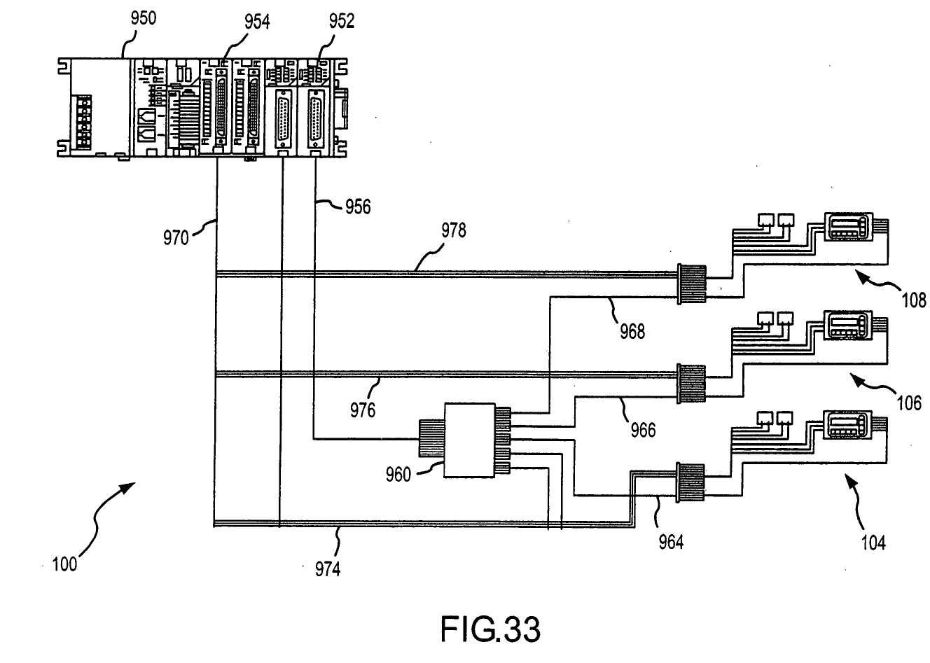

Referring to FIG. 33, the system 100 typically includes a controller 950. The controller 950 may be a standard system controller. In one embodiment, the controller 950 is DirectLOGIC 205 controller available from Koyo Electronics Industries Co., Ltd. of Kodaira city Tokyo, Japan. The controller 950 includes a module data connector 952 and a module power supply connector 954. A main data line 956 leads from the module data connector 952 to a multiplexer 960, which is connected to several module data lines 964, 966, 968, each leading to a respective module 104, 106, 108. The module power supply connector 954 is connected to a main module power line 970 that splits into several module power lines 974, 976, 978 (each having positive, negative, and ground lines), each leading to a respective module 104, 106, 108.

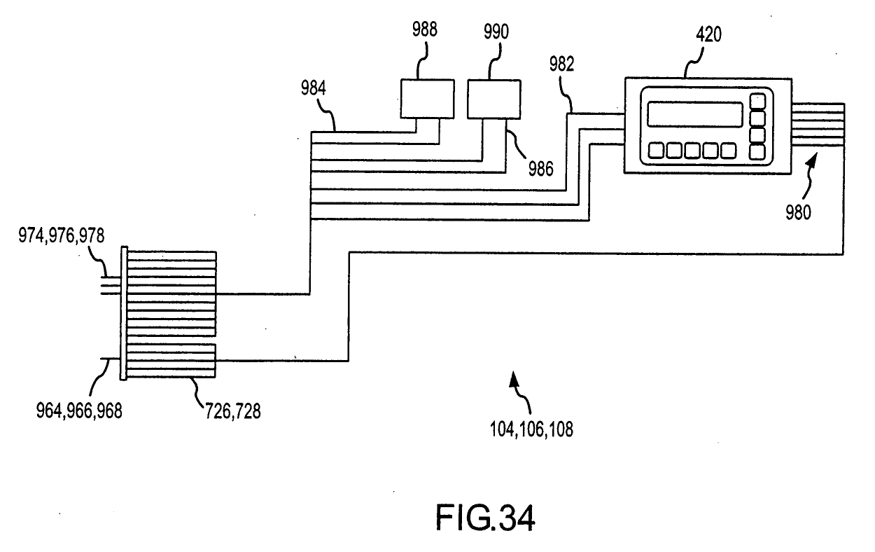

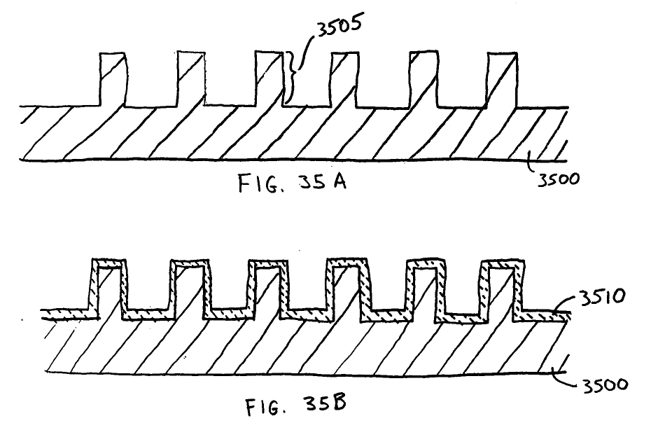

Referring to FIG. 34, the module data lines 964, 966, 968 and the module power lines 974, 976, 978 each lead to the male and female signal line fittings 726, 728 of a module 104, 106, 108. From the fittings 726, 728, multiple display data lines 980 lead to the user interface screen 420 to provide the data (such as voltage, current, and power produced by the module 104, 106, 108) to be displayed on the screen 420 from the controller 950 (FIG. 33). The user interface screen 420 and the shield for the screen are connected to ground. A display power line 982 is connected to the module power line 974, 976, 978 and supplies power to the user interface screen 420. Upper and lower temperature transducer lines 984, 986 lead to respective upper and lower temperature transducers 988, 990. Each transducer line 984, 986 includes positive and negative lines that connect to the associated transducer 988, 990. The respective upper and lower transducers 984, 986 are located on the top and bottom of the fuel cell stack 594 (FIG. 12). The temperature transducers 988, 990 are rapid data transducers. In one embodiment, the temperature transducers 988, 990 are platinum rapid data transducers. The signals from the transducers 988, 990 are returned to the controller 950 (FIG. 33), and may be used to display the temperature of the module on the user interface screen 420. In that case, the transducer signal is preferably transmitted to the controller 950 (FIG. 33) and then transmitted back to the user interface screen 420.

The controller 950 of FIG. 33 also can receive signals from and transmit signals to other components of the system 100. For example, the controller 950 may receive data concerning the voltage, current, and power from the modules 104, 106, 108 and from an array of batteries 992 (FIG. 5). The controller 950 can be connected to a main display screen (not shown) that displays values representing characteristics of the modules 104, 106, 108 and other parts of the system 100. The controller 950 can then flip a switch to connect the circuit 132 (FIG. 2) to the batteries 992 (FIG. 5) or the modules 104, 106, 108. Preferably, the circuit 132 is connected to the batteries 992 if the voltage in the batteries 992 is higher than the voltage in the modules 104, 106, 108. Likewise, the circuit 132 is connected to the modules 104, 106, 108 if the voltage in the modules 104, 106, 108 is higher than the voltage in the batteries 992 (FIG. 5). Batteries 992 can be recharged with power from the modules 104, 106, 108. The controller 950 also can be used to operate the various valves described with reference to FIG. 1, and many of the start-up and run-time processes described below can be executed in an automated manner using signals from the controller 950.

Because many components of the system 100 can be standard off-the-shelf components (although many such components are used and arranged in new ways), and others use standard manufacturing and assembly techniques, much of the assembly will be readily apparent to a person of ordinary skill in the art and will not be described in detail herein.

Referring to FIG. 1, the fuel cell system 100 is started by activating the pre-heater 194 and opening the valves 192, 193 to allow water flow to the pre-heater 194. The water passes from the water supply source 188 to the pre-heater 194, which heats the water to produce steam. After the steam within the pre-heater 194 is heated, preferably to about 240° Celsius, the valve 212 is opened so that steam passes through the steam supply line 210 to the vaporizer 172, where it heats the vaporizer 172. The steam exits the vaporizer 172 and passes through the reactor 180, also heating the reactor 180. In the reactor 180, the steam condenses and the resulting water is returned to the pre-heater 194 so that it can be recirculated through the water supply sub-system.

Once the water heats the vaporizer 172 (preferably to about 180° Celsius) and the reactor 180, valve 170 is opened to allow fuel to flow through the hydrogen generation sub-system 102, and valves 320, 322, 324 are opened to allow the flow of hydrogen through the modules 104, 106, 108. The fan 338 is activated and valves 350, 352, 354, 356 are opened to allow air to flow through the air supply sub-system 110 and the modules 104, 106, 108.

In operation, the hydrocarbon-based fuel exits the fuel supply 140 and passes through the fuel filter 162, where sulfur is removed from the fuel. The fuel then passes to the vaporizer 172, where it is vaporized, and through the pressure regulator 174, where a desired fuel pressure is obtained, as described above. The hydrocarbon fuel then mixes with steam and passes into the reactor 180.

Referring to FIG. 4, in the reactor 180 the hydrocarbon fuel first passes through the activated carbon filter 242. The carbon filter 242 removes sulfides from the fuel. Specifically, the sulfides are attracted to a sulfide attractant, such as NaOH, in the carbon filter 242. Thus, the sulfides generally bond to the attractant and remain within the carbon filter 242. As the hydrocarbon fuel passes through the carbon filter 242, some other byproducts may pass out of the filter 242 and to the waste fitting 282, while others may stay within the filter 242.

The resulting cleaned hydrocarbon fuel passes to the catalyst filter 250. As the fuel passes through the reactor, the catalysts urge the hydrogen and carbon from the fuel to separate. The catalysts also attract byproducts and convert carbon monoxide to carbon dioxide. The platinum, tin, ruthenium and chromium trioxide all catalyze reactions with byproducts of the reaction of the hydrocarbon fuel, including impurities that may be present in different hydrocarbon fuels. The reactions preferably either bond the byproducts to the catalysts, produce other byproducts that can be exhausted from the reactor 180, or produce other byproducts that will themselves bond to the catalysts or will be otherwise captured within the filter structure. As an example, if essentially pure propane (C₃H₈) is passed through the catalyst filter 250, the tin in the first catalyst filter section 252 attracts carbon from the hydrocarbon fuel. The carbon joins with oxygen from water to form carbon monoxide and carbon dioxide. The tin also induces the carbon monoxide to react with water to produce carbon dioxide, a less hazardous byproduct than carbon monoxide. The platinum generally attracts hydrogen and catalyzes the formation of hydrogen gas (H₂). In the second and third catalyst filter sections 254, 256 the platinum, ruthenium, and chromium trioxide similarly attract byproducts and catalyze reactions with many byproducts that are commonly present in hydrocarbon fuels such as natural gas and methanol. Some byproducts may remain within the catalyst filter 250, while others may exit through the waste fitting 282.

The hydrogen that is split off from the hydrocarbon fuel in the catalyst filter 250 continues through the filter 250 to the membrane plates 258. Thus, the catalyst filter 250 produces substantially pure hydrogen gas, typically about ninety-five percent or greater hydrogen. However, some byproducts may remain in the hydrogen gas.

Thus, the hydrogen gas passes through the membrane plates 258. As it does so, the platinum coating on the membrane plates 258 catalyzes reactions that remove byproducts from the hydrogen gas producing essentially pure hydrogen gas (typically greater than 99% pure, and more preferably greater than 99.5% pure). The small amount of remaining byproducts can include carbon monoxide and carbon dioxide, among other impurities. As discussed above, tin oxide is included in the catalyst layers 628, 678 of the fuel cells 112 to attract carbon monoxide and catalyze a reaction that converts it to carbon dioxide within the fuel cells 112.

Notably, the hydrogen gas passes easily through the ceramic structure of the catalyst filter 250 and through the membrane plates 258. Indeed, as the reactions in the reactor 180 occur, the environment of the reactor 180 is heated, and specifically the hydrogen gas is heated. Because of its increased energy, the heated hydrogen gas passes through the reactor 180 even more quickly than cool hydrogen gas. In one embodiment, the reactor operates at a temperature of from about 100° Celsius to about 750° Celsius, and most typically at temperature of about 350° Celsius. The temperature within the reactor 180 can be varied by varying the temperature of the steam leaving the pre-heater 194. In contrast to the hydrogen, larger molecules, such as waste and impurity molecules, cannot easily pass through the ceramic structure of the catalyst filter 250 or the membrane plates 258. Thus, those waste and impurity molecules generally do not pass through to the outlet fitting 280.

Alternatively, some other source of hydrogen could be used. For example, the fuel cell system could use bottled H₂ gas, rather than extracting H₂ gas from hydrocarbon fuels.

Referring back to FIG. 1, the hydrogen gas exits the reactor 180 and passes into the modules 104, 106, 108. More specifically, referring to FIGS. 15-16, the fuel passes through hydrogen supply manifolds 480 (FIG. 8) of each module 104, 106, 108 and into inlet gaps or windows 622 in fuel cells 112. As the hydrogen continues into each fuel cell 112, it meets obstacles or pillars 620 that interrupt its flow and split the flow into many separate flow channels 625. The flow of hydrogen is thereby slowed as it passes through the flow channels 625 through the pillars 620.

Referring to FIG. 13, as the hydrogen contacts the platinum catalyst on the top catalyst layer 628, protons are produced and are absorbed by the top proton absorbing layer 630. The protons then pass through the membrane 130 to the bottom proton absorbing layer 680 and into the bottom flow channels 675.

The shed electrons are electrically attracted to the positive charge on the cathode side 116 created by the presence of the protons passing through the membrane 130. However, the electrons cannot pass through the membrane 130. Additionally, the insulating oxide rings 632, 682 and the insulating silicone gasket ring 634 prevent the electrons from passing around the membrane 130 within the fuel cell 112. Thus, when the electrons are provided with an electric circuit 132 (FIG. 2) from the top contact layer 610 to the bottom contact layer 660, they pass as an electric current from the top flow channels 625, through the conductive layers 628, 626, 614, 612, 610 in the top assembly 910, through the circuit 132, and through the conductive layers 660, 662, 664, 676, 678 in the bottom assembly 912 to the bottom flow channels 675. The electrons passing through the circuit 132 produce electric power.

Referring back to FIG. 1, air is blown into main air supply line 340 by a fan 338. The air passes into the modules 104, 106, 108. More specifically, referring to FIGS. 15-16, the air passes through air supply manifolds 560 (FIG. 10) of each module 104, 106, 108 and into inlet gaps or windows 672 in fuel cells 112. Alternatively, some other source of oxidant could be used, such as a pressurized tank of O₂ gas. As the air continues through the fuel cell 112, it meets obstacles or pillars 670 that interrupt its flow and split the flow into many separate flow channels 675. The flow of air is thereby slowed as it passes through the flow channels 675 between the pillars 670.

Referring to FIG. 13, as the air contacts the platinum catalyst on the bottom catalyst layer 678, the O₂ molecules are encouraged by the platinum to break into oxygen atoms that react with the protons to form water. The water, along with any unreacted air, passes out of the fuel cell through the bottom outlet gap 674 (FIG. 15), which is exhausted from the system 100 through the module air exhaust lines 864, 866, 868 and the main air exhaust line 880 (FIG. 1).

Referring to FIG. 1, while the fuel cell system 100 is activated (i.e., producing electric power), one or more of the modules 104, 106, 108 can be deactivated (i.e., not producing electric power) without interrupting operation of the overall system. This can be useful, for example, when one of the modules 104, 106, 108 needs maintenance. The module 104, 106, 108 can be electrically and fluidly disconnected from the system 100 while the remaining modules 104, 106, 108 continue to operate, producing electric power. If the modules 104, 106, 108 are connected in parallel, so long as the load on the overall system 100 is not too great, the voltage produced by the system 100 should remain substantially constant even though a module 104, 106, 108 has been removed.

During operation, if the system 100 is set so that substantially no hydrogen is exhausted from the fuel cells 112 (FIGS. 12-13), the module hydrogen exhaust valves 844, 846, 848 are closed. However, the valves 844, 846, 848 are opened intermittently to allow any gases that may have built up in the fuel cells 112 (FIGS. 12-13) to be released. In one embodiment, about every two minutes the module hydrogen exhaust valves 844, 846, 848 are opened for about two seconds and are then closed again.

Additionally, during operation, carbon monoxide may build up within the top catalyst layer 628 (FIG. 13). Thus, periodically (for example, about every 400 hours of operation, or when the voltage of a module drops below a predetermined level) each of the modules 104, 106, 108 may be cleaned with cleaning fluid to remove the carbon monoxide. During the cleaning of a particular module 104, 106, 108, the remaining modules 104, 106, 108 remain active. For example, to clean carbon monoxide from the fuel cells 112 within module 104, module 104 is deactivated by closing the module hydrogen supply valve 350 to that particular module 104. The corresponding module cleaning fluid supply valve 380 and the main cleaning fluid supply valve 390 are then opened so that hydrogen peroxide passes into the anode flow channels 625 in the fuel cells 112 within the module 104. The hydrogen peroxide induces the carbon monoxide to separate from the top catalyst layer 628 (FIG. 13) and catalyzes a reaction that yields carbon dioxide from the carbon monoxide. The hydrogen peroxide and impurities are exhausted from the system through the module hydrogen exhaust line 834 and the main hydrogen exhaust line 850. The anode flow channels 625 of the module 104 should be flushed with air or some other gas before and after being cleaned with hydrogen peroxide. During cleaning of the module 104, the remaining modules 106, 108 can remain active so that the operation of the system 100 is not interrupted.

Carbon Coating of Silicon Substrate

According to one embodiment of the invention, the silicon flow field plates can be covered with carbon to provide increased conductivity, i.e., decreased resistance of the fuel cell electrode. While doping the silicon was previously noted as one possibility for providing sufficient conductivity, the long term effects of operating a silicon substrate electrode in the corrosive environment of a fuel cell—for example an environment that contains phosphoric acid—could lead to a shorter operational life of the fuel cell electrode. Namely, in the present embodiment, the silicon can be coated with carbon so as to prevent the silicon from being etched by the corrosive operating environment while at the same time still providing good conductivity via the carbon material.

FIGS. 35A and 35B illustrate a carbon coated silicon electrode according to one embodiment of the invention. FIG. 35A shows a cross-section of a silicon electrode 3500 having multiple pillars such as pillar 3505. As described above, a flow field for a fuel cell electrode can be configured by etching the silicon using well known semiconductor processing techniques. The flow field can be configured in a variety of patterns to facilitate the thorough circulation of reactant gases during operation of the fuel cell. In the embodiment shown in FIG. 35A, the flow field is formed from multiple pillars, such as pillar 3505. Once the silicon substrate has been configured in the desired flow field configuration, a layer of carbon 3510 can be deposited over the silicon to form a carbon coated silicon electrode, as shown in FIG. 35B. The carbon is a good conductor of electricity and has higher conductivity than pure silicon. Thus, by coating the silicon flow field, the conductivity of the fuel cell electrode is improved. Similarly, carbon resists the corrosive effects of most acids. Thus, it will not be etched over long term exposure to such acids. For example, phosphoric acid is an acid that is commonly present in a fuel cell environment since it can serve as a transport mechanism for positive charges. However, carbon is not etched by phosphoric acid. Thus, the use of carbon in a phosphoric acid environment allows the carbon to conduct electrons produced from the fuel cell reaction(s) without etching away of the carbon during long term exposure to the phosphoric acid. In contrast, silicon or doped silicon (for example, silicon doped with boron) would be etched by the phosphoric acid when operating in the phosphoric acid environment.

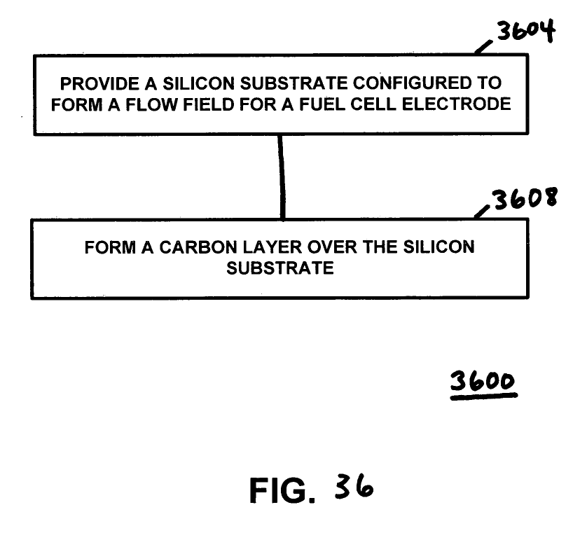

FIG. 36 illustrates a flowchart demonstrating a method of forming a carbon coated silicon electrode in accordance with one embodiment of the invention. Namely, flowchart 3600 illustrates that in block 3604 a silicon substrate is provided. The silicon substrate can be configured with a flow field for use as part of a fuel cell electrode. In block 3608, a carbon layer is formed over the silicon substrate. It should be noted that an intermediate layer(s) can be formed on the silicon substrate prior to forming the carbon layer. For example, one might choose to apply an adhesion layer to the silicon prior to forming the carbon layer on top of the adhesion layer. Similarly, one might even choose to apply multiple intermediate layers prior to applying the carbon layer.

The forming of the carbon layer can be accomplished in a variety of ways. For example, sputtering, evaporative deposition, epitaxy, or chemical vapor deposition of carbon could be used to apply the carbon to the silicon substrate. Similarly, a carbon powder could be applied and heated so as to establish a carbon nanoparticle film over the silicon. According to yet another embodiment, pyrolysis of an organic material, such as an organic polymer, could be used to apply the carbon to the silicon. This could be accomplished by applying an organic material, such as photoresist, to the silicon and then heating it so as to leave only a carbon layer on the silicon. While the thickness of the carbon layer can vary, the carbon layer should be sufficient to cover the silicon that is exposed to the corrosive fuel cell environment during operation of the fuel cell. For example, the thickness of the carbon layer could be about 2 microns thick.

While the above process has been described as being applied to a pillared flow field fuel cell, it should be understood that the pillared flow field is merely an example and that a carbon coated silicon electrode could be implemented with other flow field designs that utilize a silicon substrate.

Metallization of Silicon Electrode

According to one embodiment of the invention, the silicon flow field plates can be covered with a metal to provide increased conductivity, i.e., decreased resistance of the fuel cell electrode. While a silicon electrode provides the ability to form precise flow field patterns on thin silicon wafers, the silicon can be degraded by the corrosive environment of the fuel cell over long term use. For example, the high temperature, high humidity, and acidic atmosphere of a fuel cell can lead to degradation of the silicon over long term use. Furthermore, silicon is merely a semiconductor and does not have the high conductivity that metals have. Even a doped silicon substrate (such as silicon doped with boron) does not equal the conductivity of metals. Thus, according to one embodiment of the invention, gold can be utilized to cover the silicon. Gold is not only a material that has a high conductivity (i.e., low resistance) but it is also impervious to most acids and thus will not corrode easily in a fuel cell environment.

However, gold does not directly adhere well to silicon. Thus, according to one embodiment of the invention, a method is provided to effectively fabricate a silicon substrate flow field with a gold covering. Namely, this can be accomplished by utilizing an intermediate adhesion layer between the gold and the silicon. For example, it has been discovered that tantalum can effectively bond with both gold and silicon in a fuel cell environment.

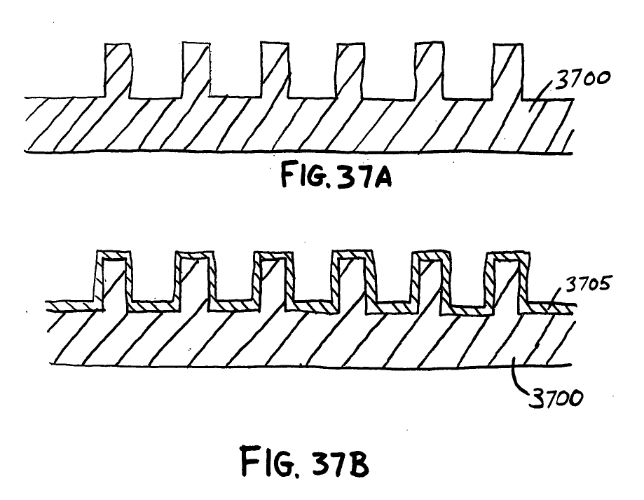

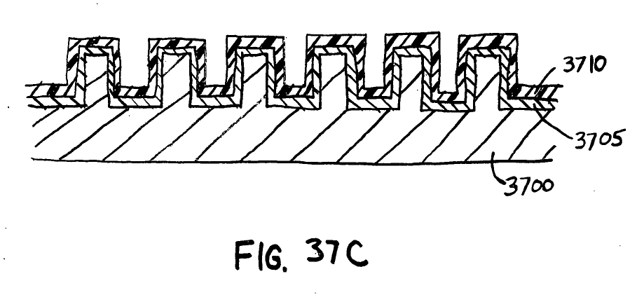

FIGS. 37A, 37B and 37C illustrate the formation of a gold covered silicon fuel cell flow field in accordance with one embodiment of the invention. Namely, FIG. 37A shows that a silicon substrate 3700 can be etched so as to form a flow field for the fuel cell electrode. Furthermore, FIG. 37B shows a layer of intermediate material 3705, such as tantalum, which will readily adhere to the silicon deposited on the silicon substrate 3700. Finally, FIG. 37C illustrates that a metal layer 3710, such as gold, is deposited on the intermediate layer 3705, which in turn is shown as deposited on the silicon substrate 3700. Tantalum is useful as the intermediate layer in that it adheres well to both silicon and gold. Thus, it can be used to couple the gold with the silicon and provide not only a highly conductive electrode but also one that will not easily be corroded by the operating conditions of a fuel cell. It is preferred that the intermediate layer is a metal that does not form a bimetallic electromotive corrosion with the gold when in the presence of acid and current. Tantalum meets that preferred requirement, as well. As an alternative, tungsten could be used in place of gold.

While FIGS. 37A, 37B, and 37C illustrate an electrode that is completely covered by the intermediate layer and highly conductive layer, it should be noted that a partial covering of the electrode could be implemented as well. For example, one may choose only to cover the tops of the pillars shown in FIGS. 37A, 37B, and 37C with the intermediate layer and highly conductive layer. Such an embodiment could be implemented when one wanted to concentrate on the conductivity between the tops of the pillars and the adjoining material. The adjoining material could be a gas diffusion layer (such as a carbon fiber material) or even a membrane for transporting positive charge between the anode and cathode of the fuel cell. Furthermore, the adjoining material could be partially coated with metal, as well, so as to increase the conductivity between the fuel cell electrode and the adjoining material. The increase in conductivity would allow less to be used in joining the electrode and the adjoining material—since the high conductivity of the metal would facilitate the electrical connection between the electrode and the adjoining material. The reduced force required to bond the materials would result in less chance of the thin silicon electrode from being damaged. Similarly, the reduced force would cause less damage to any membrane—such as a proton exchange membrane or polymer electrolyte membrane from being damaged.

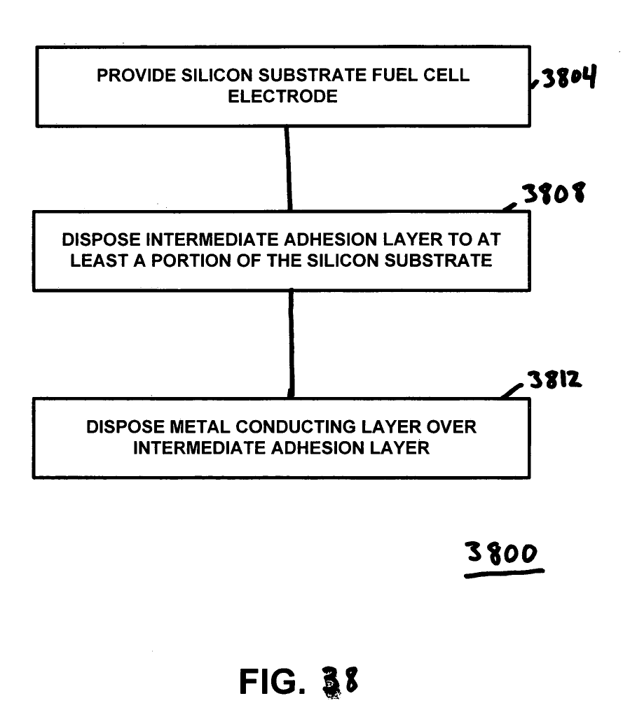

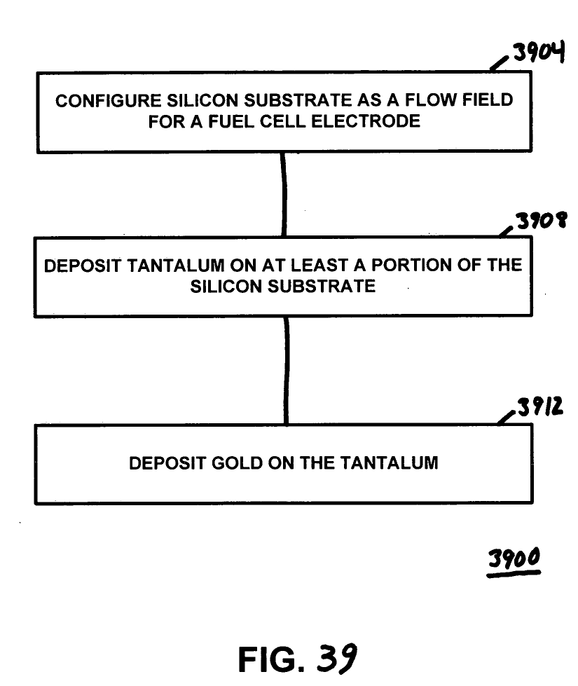

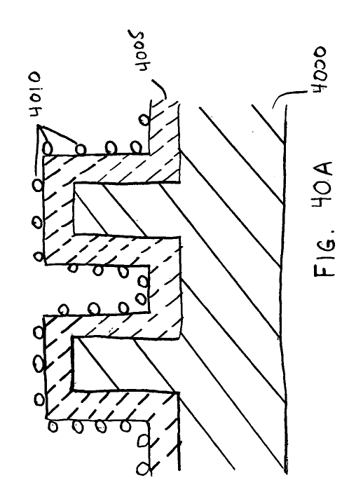

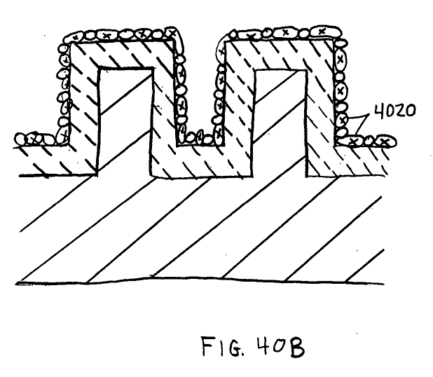

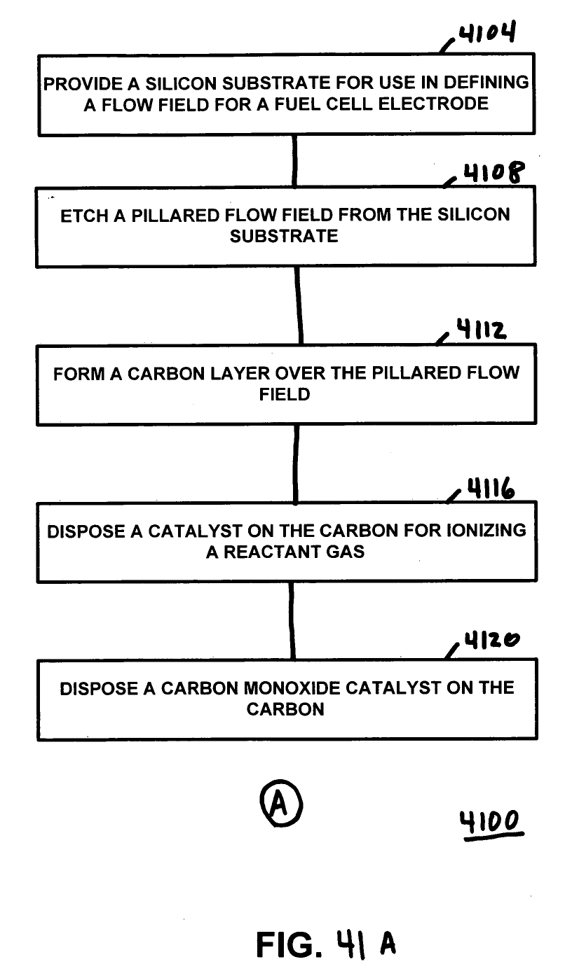

FIGS. 38 and 39 illustrate methods of fabricating a fuel cell electrode using an intermediate layer. Namely, FIG. 38 illustrates a flowchart 3800 that demonstrates a method of fabricating a fuel cell electrode according to one embodiment of the invention. In block 3804, a silicon substrate fuel cell electrode is provided. For example, this fuel cell electrode can be the type that is configured with a pillared design. In block 3808, an intermediate adhesion layer is disposed over at least a portion of the silicon substrate. Thus, it is not necessary that the adhesion layer be disposed over the entire surface area of the flow field; however, such an embodiment could be utilized. In block 3812, a metal conducting layer is disposed over the intermediate adhesion layer.

A more detailed embodiment can be seen in FIG. 39. Namely, in flowchart 3900 of FIG. 39, a silicon substrate is shown as being configured with a flow field for use in a fuel cell electrode, as shown in block 3904. In block 3908, tantalum is deposited on at least a portion of the silicon substrate. Tantalum is useful in that it adheres well to both silicon and gold. Thus, it can serve as an intermediate layer for coupling gold with silicon. In block 3912, gold is deposited on the tantalum. One could cover the entire flow field with the tantalum and gold or merely a portion of the flow field, as desired.

The forming of the intermediate layer and highly conductive layer can be accomplished in a variety of ways. For example, sputtering, evaporative deposition, epitaxy, or chemical vapor deposition of the intermediate material and highly conductive metal could be used. For example, tantalum could be sputtered onto the silicon and then gold could be sputtered onto the tantalum. It should be noted that the gold should be deposited prior to exposing the tantalum to oxygen. Oxygen will form an oxide with the tantalum—and gold will not adhere to the oxide. Thus, it is preferred to perform the deposition of the gold immediately following the deposition of the tantalum.

Application of Catalyst and Electrolyte Retainer to Flow Field

In accordance with another embodiment of the invention, a catalyst for a reactant gas can be deposited on the flow field surface. Furthermore, a material such as a membrane can be applied to the flow field surface to couple electrolyte used in the fuel cell. FIG. 40A illustrates a cross-section of a carbon coated fuel cell electrode with a catalyst deposited on the pillars of the pillared flow field. A silicon substrate 4000 is covered with a carbon layer 4005. The catalyst particles 4010 are shown adhering to the carbon. The catalyst particles will typically be catalysts used to ionize reactant gases such as hydrogen or oxygen or to remove contaminants such as carbon monoxide. Thus, for example, platinum or palladium can be used as catalysts to ionize hydrogen and oxygen, while ruthenium or tin could be used to convert a carbon monoxide molecule to carbon dioxide. Similarly, combinations of the catalysts could be deposited as alloys. Thus, for example, one might choose to deposit platinum and ruthenium on a flow field electrode when hydrogen is supplied as the reactant gas and contains a minimal amount of carbon monoxide as a contaminant. Similarly, one might choose to deposit merely platinum on the electrode used to process air or pure oxygen as the reactant gas. The deposition of the catalysts can be accomplished by sputtering, evaporative deposition, epitaxy, chemical vapor deposition or dip coating, for example. While for purposes of this example a carbon coated silicon electrode was used as the example, the catalysts could also be applied to a metal coated silicon electrode or even to a doped silicon electrode.

In addition to the deposition of the catalysts, a material for assisting in the retention of electrolyte can be applied to the flow field. During operation of the fuel cell, electrolyte from an electrolyte membrane will oftentimes migrate from the membrane positioned between the anode and cathode of the fuel cell—such an electrolyte membrane is used to pass protons between the anode and cathode of the fuel cell but does not allow passage of electrons. The membrane can utilize an electrolyte such as phosphoric acid to serve as the transport mechanism for the positive charge across the membrane. Phosphoric acid is particularly well-suited for this task.

Thus, according to one embodiment an electrolyte retaining material 4020 can be deposited on the electrode as shown in FIG. 40B. For example, it can be deposited on the carbon coated silicon electrode and metal coated silicon electrode described above. If phosphoric acid is used, both carbon and gold will be resistant to the corrosive effects of the phosphoric acid.

One type of material that can be deposited as the electrolyte retaining material is polybenzimidazole which is commonly referred to as PBI. This type of material can be placed in solution and then spray coated on the previously deposited catalyst layer. The PBI will then form a very thin layer on the electrode without completely covering the catalyst. Thus, as the electrolyte migrates to the electrode, it can be retained in place on the electrode without being washed away by the water by-product produced by the fuel cell.

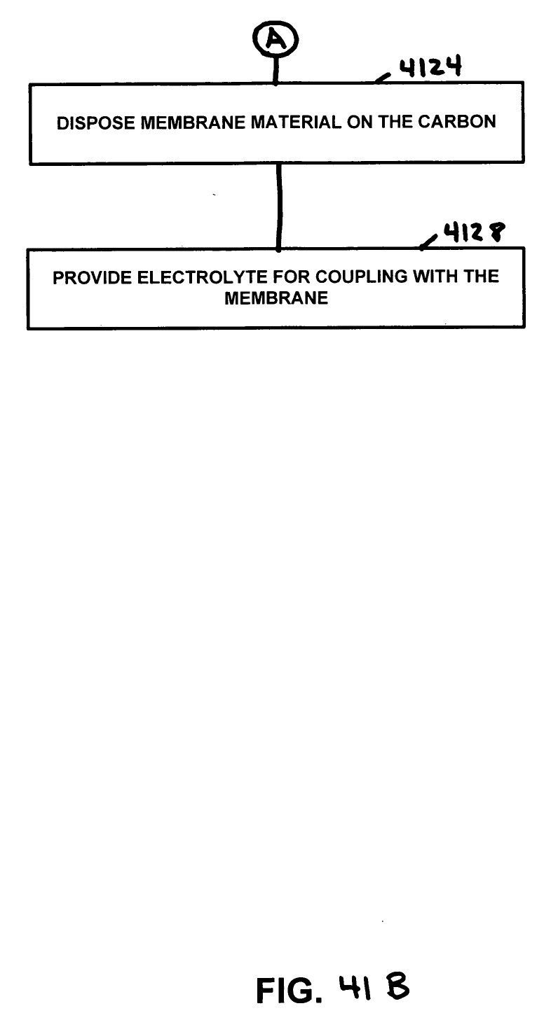

FIGS. 41A and 41B illustrate a method forming a fuel cell electrode in accordance with one embodiment of the invention where a carbon coated fuel cell electrode is used. Namely, flowchart 4100 shows in block 4104 that a silicon substrate is provided for use in defining a flow field for a fuel cell electrode. Pillars are etched in the silicon substrate so as to form a pillared flow field for the fuel cell electrode, as shown in block 4108. In block 4112, a carbon layer is formed over the pillared flow field. Then, as shown in block 4116, a catalyst can be disposed over the carbon for use in ionizing a reactant gas, such as hydrogen or oxygen. If desired, a carbon monoxide catalyst, such as tin or ruthenium, can be deposited on the carbon, as well. This is shown in block 4120. The carbon monoxide catalyst would be used to assist in the conversion of any carbon monoxide present in the fuel source to carbon dioxide or other by-product. Thus, this catalyst would not necessarily need to be present on the cathode electrode (at least for a proton exchange membrane fuel cell). In block 4124, an electrolyte retention material can be disposed on the carbon—such as PBI membrane. This material assists in the retention of electrolyte and effectively couples the electrolyte with the electrode as shown in block 4128. The electrolyte can be provided by migration from the electrolyte membrane between the anode and cathode.

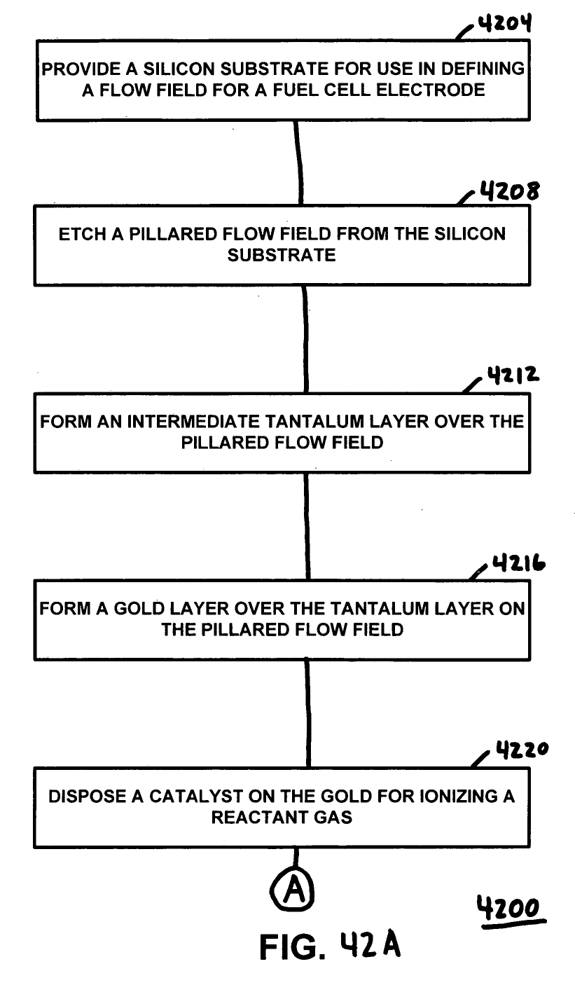

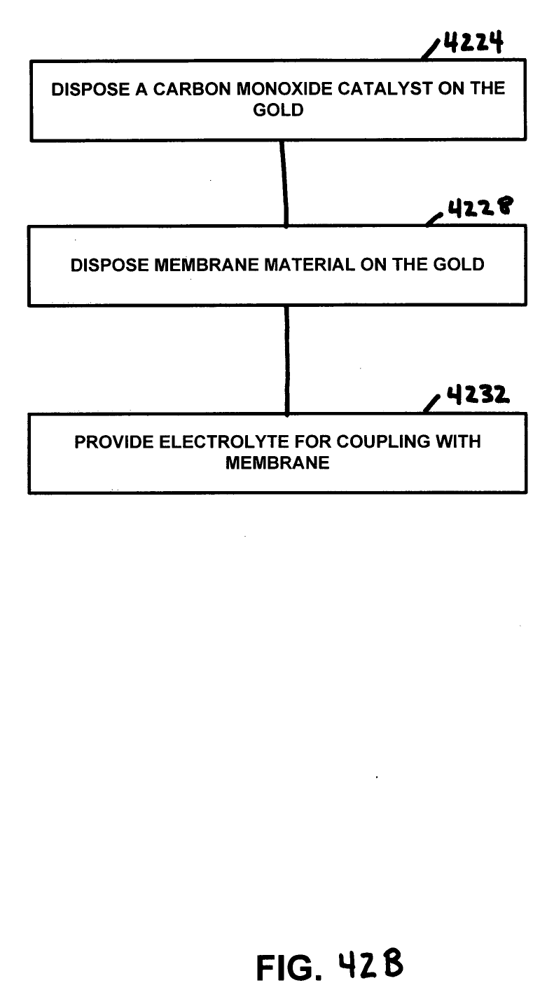

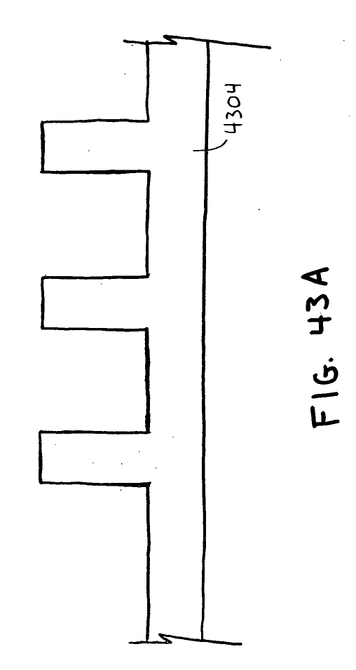

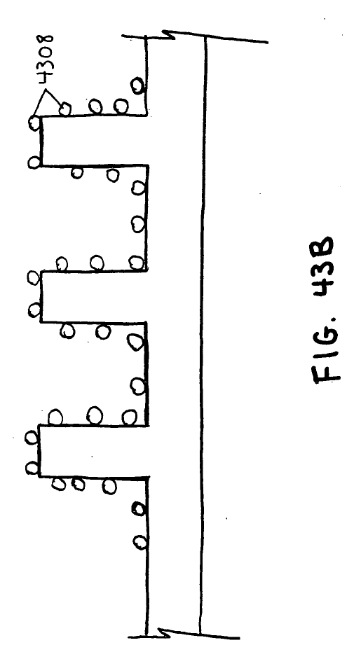

FIGS. 42A and 42B illustrate a very similar process to that shown in FIGS. 41A and 41B; however, in FIGS. 42A and 42B, a metal covered silicon electrode is used rather than a carbon coated silicon electrode. Thus, flowchart 4200 shows in block 4204 that a silicon substrate is provided for use in defining a flow field for a fuel cell electrode. In block 4208, a pillared flow field can be etched from the silicon substrate. Alternative flow field designs could be formed, as well. In block 4212, an intermediate binding layer, such as tantalum, can be formed over the silicon substrate. Then, in block 4216 a highly conductive metal, such as gold, can be formed over the intermediate layer. In block 4220, a catalyst can be disposed over the gold, for example. The catalyst can serve to ionize a reactant gas circulated across the flow field of the fuel cell electrode during use. If desired, a carbon monoxide catalyst for removing carbon monoxide can also be deposited. This is shown in block 4224 where the carbon monoxide catalyst is deposited on the gold layer. In block 4228, an electrolyte retaining material can be deposited on the highly conductive metal. Thus, for example, PBI material can be applied to the gold layer. The electrolyte retaining material serves to couple the electrolyte with the flow field of the electrode, as shown in block 4232.

Elimination of Gas Diffusion Layer

According to one embodiment of the invention, a fuel cell can be configured so as to eliminate the gas diffusion layer that is commonly used in many fuel cell systems. The gas diffusion layer serves to distribute reactant gases in such systems. It is typically configured as part of a membrane electrode assembly (MEA) and often takes the form of a carbon paper or carbon fibers. It can also be used to support catalyst material that facilitates, for example, the ionization of the reactant gas on the anode side of the fuel cell.

Such gas diffusion layers add to the cost of the fuel cell and thus offset the efficiency benefits that they produce, if any. Consequently, the present embodiment which eliminates the need for a gas diffusion layer can assist in decreasing the cost of a fuel cell. Namely, by providing a transport mechanism for positive charges used in the fuel cell reaction between the flow field plate and the fuel cell membrane, the gas diffusion layer can be eliminated so as to allow the fuel cell reactions to take place at the flow field plates. Previous attempts to try this may have failed because others failed to appreciate that an electrolyte retaining material could be deposited to the flow field. The flow field could thus hold the electrolyte via the electrolyte retaining material and prevent water produced as a by-product of the fuel cell reactions (or which leached through the membrane from the cathode side to the anode side) from washing away the electrolyte. Furthermore, a porous covering of catalyst and electrolyte retaining material can be used to facilitate the three phase boundary of gas/catalyst/electrolyte that is need for successful fuel cell operation.

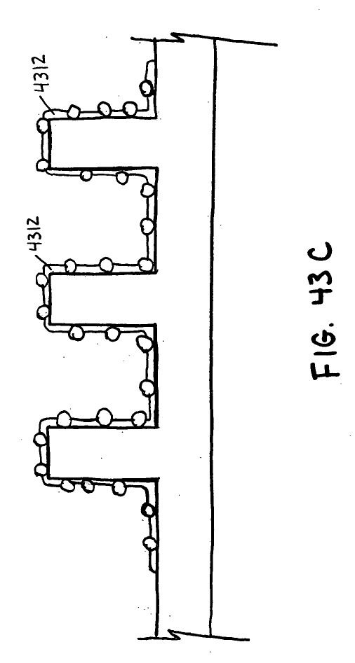

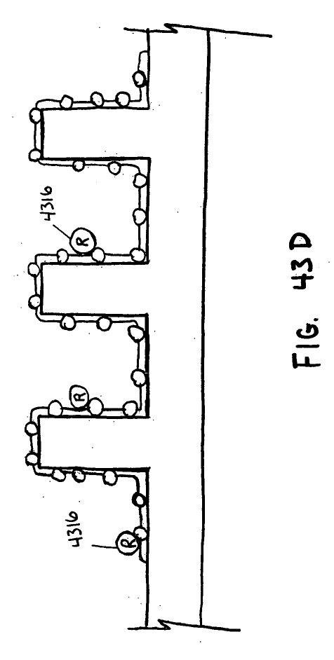

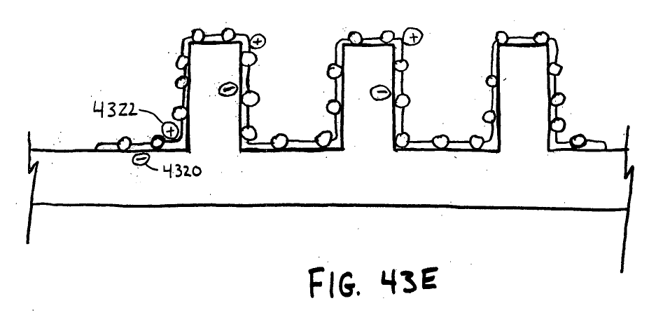

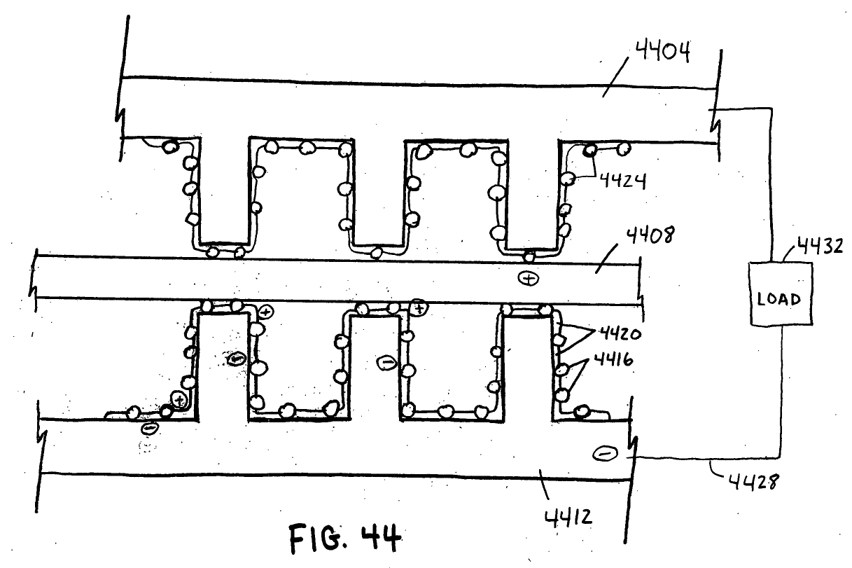

Referring now to FIGS. 43A, 43B, 43C, 43D, and 43E, an example of configuring such a flow field plate can be seen. It should be understood that while this example will be described as a doped silicon flow field plate, it is equally applicable to any other type of flow field plate regardless of material or surface coating. In FIG. 43A, a cross-section of a pillared flow field plate is shown. The flow field is shown as having a pillared design etched from the silicon. The silicon is also understood to be doped, with boron for example, to increase the conductivity of the flow field plate. In FIG. 43B, catalyst particles 4308 are shown disposed on the pillars. The catalyst material can be of a variety of forms. Essentially, the choice of the catalyst will depend on the reactant gas used. Thus, for example, if hydrogen is used, then platinum can be used as the catalyst for its ionization properties. It may be necessary depending on the selected catalyst to first deposit some intermediate binding material before depositing the catalyst. Examples of this are described herein.

The formation of the catalyst over the flow field is done in a porous manner so as to leave room for electrolyte and electrolyte retention material to be deposited. Generally, it is preferred to deposit the catalyst before applying the electrolyte—since the electrolyte may prevent the catalyst from adhering to the silicon. However, it is not necessarily required that the catalyst be applied first.

The formation of the catalyst over the flow field plate can be accomplished in a variety of manners. For example, one could use sputtering, chemical vapor deposition or evaporative vapor deposition techniques to obtain a porous pattern of catalyst over the flow field. Preferred catalysts are platinum for ionizing hydrogen on the anode side of the fuel cell and platinum for forming water from oxygen molecules and protons on the cathode side of a fuel cell—when the fuel cell utilizes hydrogen and oxygen as the reactant gases, for example. Ruthenium can be used as the catalyst to convert carbon monoxide to carbon dioxide when the carbon monoxide pollutes the hydrogen source of reactant gas.

FIG. 43C shows the formation of an electrolyte retaining material deposited on the flow field plate. In FIG. 43C, the electrolyte retaining material 4312 is shown as including electrolyte. However, the application of the electrolyte retaining material and the application of the electrolyte could take place as separate steps. One type of electrolyte retaining material is polybenzimidazole which is commonly referred to as PBI and is manufactured by Pemeas Fuel Cell Technologies in Frankfurt, Germany. This type of material forms a membrane which is useful in coupling with electrolytes—such as phosphoric acid. Phosphoric acid is a useful electrolyte in fuel cell applications as it can serve as a transport mechanism for positive charge—i.e., it can conduct positive charge. To apply this PBI material, the pbi can be emulsified in solution. For example, it can be emulsified in a solution containing phosphoric acid. Then, the solution can be spray coated on the flow field. According to one embodiment, it can be spray coated over the previously deposited porous catalyst. Dip coating techniques could be used as well and the one could control the concentration of the PBI polymer as well as the amount of time the flow field plate is submerged in solution in order to control the concentration of the PBI disposed on the flow field plate. While PBI is described in this example, other electrolyte retaining material could be utilized, as well.

FIG. 43D shows the ability of the flow field plate to provide a three phase boundary for the fuel cell reactions. Namely, reactant gas 4316 can be placed in contact with catalyst and electrolyte. Thus, when ionization is being implemented, the reactant gas can be ionized to produce electrons and a positive ion. On the other hand, when a reaction is taking place at the cathode, a positive charge or ion can be provided via the electrolyte to react with the reactant gas and catalyst. Furthermore, electrons can be transported to or from the reaction via the electrically conductive flow field plate.

FIG. 43E illustrates the transport of positive charges 4322 via the electrolyte and negative charges 4320 via the electrically conductive flow field plate.

Referring now to FIG. 44, an example of a fuel cell without a gas diffusion layer can be seen. Namely, FIG. 44 shows a first flow field plate 4404 in contact with a membrane 4408. The membrane 4408 is also in contact on its opposing side with second flow field plate 4412. The flow fields are shown as having their respective catalyst, electrolyte retaining material (and electrolyte) disposed on the flow field. Furthermore, negative charges are shown being conducted along the electrically conductive flow field plate 4412 while positive charges are shown being conducted toward the membrane 4408. A positive charge is also shown being conducted across membrane 4408 from the flow field plate 4412 to flow field plate 4404. An electrical circuit couples the flow field plates to allow negative charge to flow from plate 4412 to plate 4404 and across load 4432.

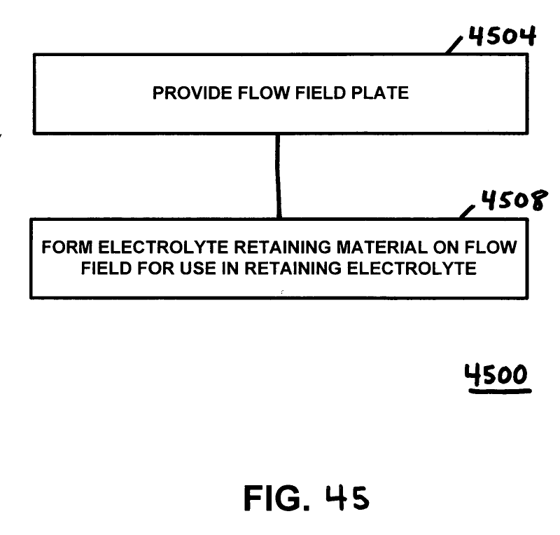

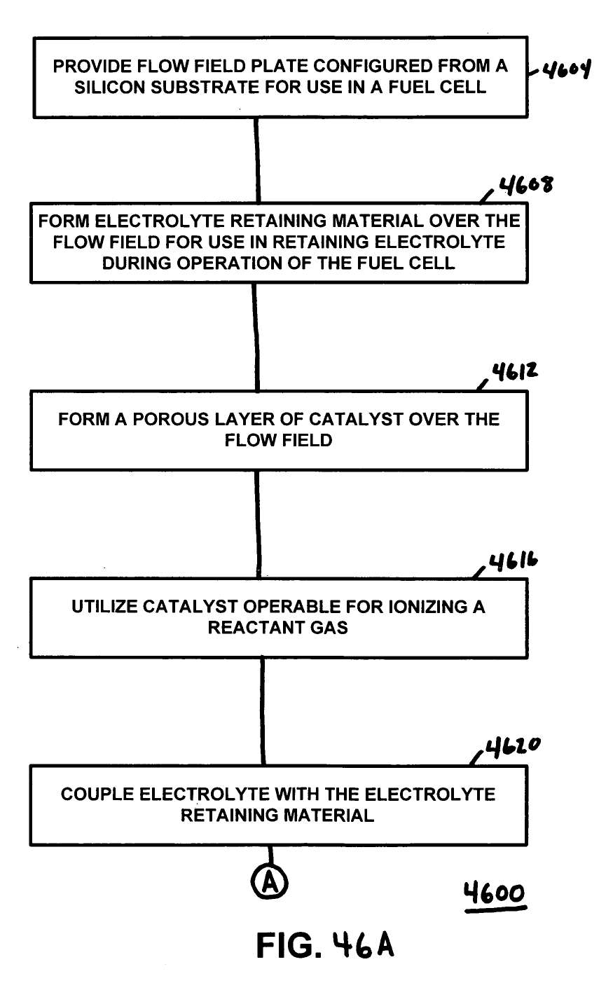

FIG. 45 illustrates a flow chart for implementing a method according to one embodiment. Namely, flow chart 4500 illustrates that a flow field plate can be provided, as shown in block 4504 and that an electrolyte retaining material can be formed on the flow field for use in retaining electrolyte, as shown in block 4508.

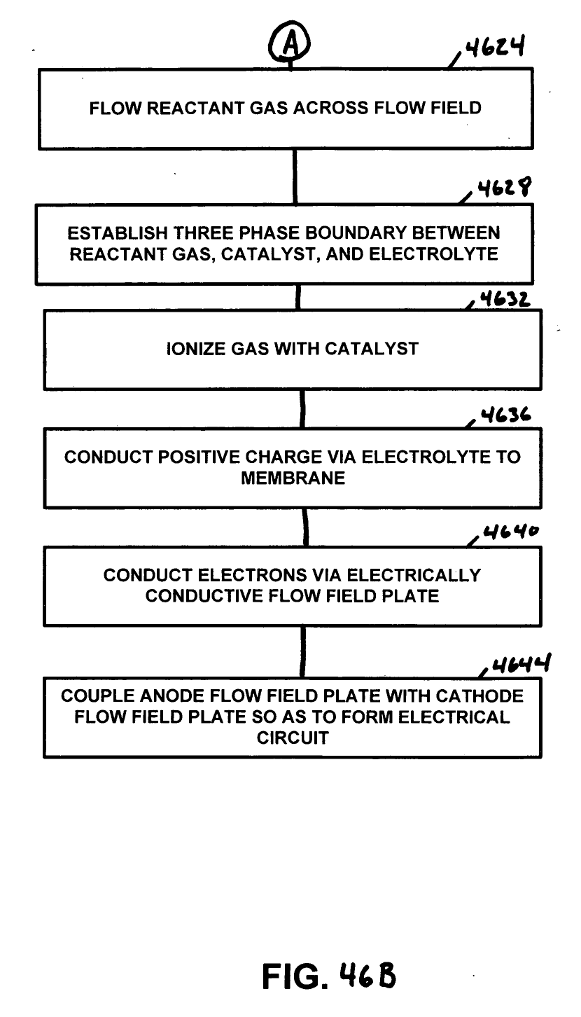

FIGS. 46A and 46B illustrate a more detailed flow chart. In flow chart 4600, a flow field plate is provided. The flow field plate can be configured from silicon as shown in block 4604 and made electrically conductive via doping or via covering with carbon or metal, for example. In block 4608, an electrolyte retaining material can be deposited over the flow field for use in retaining electrolyte during operation of the fuel cell. In block 4612, a porous layer of catalyst can be formed over the flow field. The catalyst can be operable for ionizing a reactant gas, as shown in block 4616. In block 4620, electrolyte can also be introduced to the flow plate. The electrolyte can be applied or can leach to the flow field from the membrane. The electrolyte then couples to the electrolyte retaining material. In block 4624, reactant gas is flowed across the flow field plate during operation of the fuel cell. The reactant gas establishes a three phase boundary with the electrolyte and catalyst, as illustrated in block 4628. The gas can then produce the desired reaction. For example, it can be ionized as shown in block 4632. Block 4636 illustrates that positive charge is conducted via the electrolyte. For example, it can be conducted from or to the membrane—depending on which side of the membrane it is on. Similarly, block 4640 illustrates that electrons can be conducted via electrically conductive flow field plates. Finally, the flow field plate on the anode side of the fuel cell can be electrically coupled with the flow field plate on the cathode side of the fuel cell to establish an electrical circuit, as illustrated by block 4644.

The use herein of various orientation terms such as front, back, up, down, right, left, vertical and horizontal is for convenience in describing disclosed embodiments. However, such terms should not be construed as limiting the invention to a particular orientation. For example, a module may be oriented so that the anode side of a particular fuel cell is the top, bottom, side, etc., even though the anode side has been described herein as being on the top side of the fuel cell. In addition, the term “electrode” is intended to refer to the current carrying terminals of a fuel cell. Thus, when a flow plate is used in a current carrying capacity, it is understood to be an electrode—whether it is used on the anode or the cathode side of the fuel cell.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. A fuel cell electrode comprising:
a silicon substrate configured as a flow field for a fuel cell;
an intermediate adhesion layer disposed over at least a portion of said substrate;
a metallic layer disposed over said adhesion layer.

2. The fuel cell electrode as claimed in claim 1 wherein said adhesion layer is a metal.

3. The fuel cell electrode as claimed in claim 1 wherein said adhesion layer couples said metallic layer with said silicon substrate.

4. A fuel cell electrode comprising:
a silicon substrate configured as a flow field for a fuel cell;
a layer of tantalum disposed over at least apportion of said silicon substrate;
a layer of gold disposed over said layer of tantalum.

5. The fuel cell electrode as claimed in claim 4 wherein said layer of tantalum completely covers said flow field.

6. The fuel cell electrode as claimed in claim 5 wherein said layer of gold completely covers said flow field.

7. The apparatus as claimed in claim 4 wherein said flow field is configured from a plurality of pillars etched from said silicon and wherein said tantalum layer adheres to said pillars.

8. The apparatus as claimed in claim 4 and further comprising a hydrogen-catalyst disposed on said gold for ionizing hydrogen gas.

9. The apparatus as claimed in claim 4 and further comprising an oxygen-catalyst disposed on said gold for ionizing oxygen gas.

10. The apparatus as claimed in claim 4 and further comprising a carbon monoxide-catalyst disposed on said gold for use in forming a carbon dioxide molecule from a carbon monoxide molecule.

11. The apparatus as claimed in claim 4 and further comprising:
a hydrogen-catalyst disposed on said gold for ionizing hydrogen gas;
a carbon monoxide-catalyst disposed on said gold for use in forming a carbon dioxide molecule from a carbon monoxide molecule.

12. The apparatus as claimed in claim 8 wherein said hydrogen-catalyst comprises platinum.

13. The apparatus as claimed in claim 8 wherein said hydrogen-catalyst comprises palladium.

14. The apparatus as claimed in claim 9 wherein said oxygen-catalyst comprises platinum.

15. The apparatus as claimed in claim 9 wherein said oxygen-catalyst comprises palladium.

16. The apparatus as claimed in claim 10 wherein said carbon-monoxide catalyst comprises ruthenium.

17. The apparatus as claimed in claim 4 and further comprising a phosphoric acid retaining membrane material disposed on said gold and wherein said phosphoric acid membrane material is operable for adhering phosphoric acid molecules to said gold layer.

18. The apparatus as claimed in claim 17 wherein said phosphoric acid retaining membrane material is operative during use in a fuel cell to resist washing away of phosphoric acid from said gold layer.

19. The apparatus as claimed in claim 17 and further comprising phosphoric acid coupled with said phosphoric acid retaining membrane.

20. The apparatus as claimed in claim 17 wherein said phosphoric acid retaining membrane material comprises PBI.

21. The apparatus as claimed in claim 4 and further comprising PBI material disposed on said carbon.

22. The apparatus as claimed in claim 4 wherein said silicon substrate is solid silicon.

23. The apparatus as claimed in claim 1 wherein said silicon electrode consists of non-porous silicon.

24. A method of configuring a fuel cell electrode, said method comprising:
providing a silicon substrate configured as a flow field for a fuel cell;
forming an intermediate adhesion layer over at least a portion of said substrate;
forming a metallic layer disposed over said adhesion layer.

25. The method as claimed in claim 24 and further comprising:
utilizing a metal for said adhesion layer.

26. The fuel cell electrode as claimed in claim 24 wherein said adhesion layer couples said metallic layer with said silicon substrate.

27. A method of configuring a fuel cell electrode, said method comprising:
providing a silicon substrate configured as a flow field for a fuel cell;
forming a layer of tantalum over at least a portion of said silicon substrate;
forming a layer of gold over said layer of tantalum.

28. The method as claimed in claim 4 and wherein said forming said layer of tantalum comprises forming said layer of tantalum to completely cover said flow field.

29. The method as claimed in claim 28 wherein said forming said layer of gold comprises forming said layer of gold to completely cover said flow field.

30. The method as claimed in claim 27 wherein said providing said silicon substrate comprises providing a pillared silicon substrate comprising pillars etched from said silicon substrate and wherein said forming said tantalum layer comprises disposing said tantalum layer so as to adhere to said pillars.

31. The method as claimed in claim 27 and further comprising:
disposing a hydrogen-catalyst on said gold for ionizing hydrogen gas.

32. The method as claimed in claim 27 and further comprising:
disposing an oxygen-catalyst on said gold for ionizing oxygen gas.

33. The method as claimed in claim 27 and further comprising:
disposing a carbon-monoxide catalyst on said gold for use in forming a carbon dioxide molecule from a carbon monoxide molecule.

34. The method as claimed in claim 27 and further comprising:
disposing a hydrogen-catalyst on said gold for ionizing hydrogen gas
disposing a carbon-monoxide catalyst on said gold for use in forming a carbon dioxide molecule from a carbon monoxide molecule.

35. The method as claimed in claim 31 wherein said disposing said hydrogen-catalyst comprises disposing platinum as said hydrogen-catalyst.

36. The method as claimed in claim 31 wherein said disposing said hydrogen-catalyst comprises disposing palladium as said hydrogen-catalyst.

37. The method as claimed in claim 32 wherein said disposing said oxygen-catalyst comprises disposing platinum as said oxygen-catalyst.

38. The method as claimed in claim 32 wherein said disposing said oxygen-catalyst comprises disposing palladium as said oxygen-catalyst.

39. The method as claimed in claim 33 wherein said disposing said carbon monoxide-catalyst comprises disposing ruthenium as said carbon monoxide catalyst.

40. The method as claimed in claim 27 and further comprising disposing a phosphoric acid retaining membrane material on said gold and wherein said phosphoric acid membrane material is operable for adhering phosphoric acid molecules to said gold layer.

41. The method as claimed in claim 40 and further comprising disposing said phosphoric acid retaining membrane material so as to be operative during use in a fuel cell to resist washing away of phosphoric acid from said gold layer.

42. The method as claimed in claim 40 and further comprising:
coupling phosphoric acid with said phosphoric acid retaining membrane.

43. The method as claimed in claim 40 wherein said disposing a phosphoric acid retaining membrane comprises disposing PBI on said gold.

44. The method as claimed in claim 27 and further comprising:
disposing PBI material on said gold.

45. The method as claimed in claim 44 wherein said providing said silicon substrate comprises:
providing a solid silicon substrate.

46. The method as claimed in claim 27 wherein said providing said silicon electrode comprises providing a non-porous silicon electrode.

47. A fuel cell comprising:
an anode comprising:
a first silicon substrate configured as a first flow field; and
a first intermediate coating disposed over said first silicon substrate;
a first metal coating disposed over said first intermediate coating;
a cathode comprising:
a second silicon substrate configured as a second flow field; and
a second intermediate coating disposed over said second silicon substrate;
a second metal coating disposed over said second intermediate coating;
a membrane disposed between said anode and said cathode configured to permit the passage of protons and prevent the passage of electrons between said anode and said cathode;
a circuit electrically coupling said first metal coating with said second metal coating.

48. A method of configuring a fuel cell, said method comprising:
providing an anode comprising:
a first silicon substrate configured as a first flow field; and
a first intermediate coating disposed over said first silicon substrate;
a first metal coating disposed over said first intermediate coating;
providing a cathode comprising:
a second silicon substrate configured as a second flow field; and
a second intermediate coating disposed over said second silicon substrate;
a second metal coating disposed over said second intermediate coating;
disposing a membrane between said anode and said cathode configured to permit the passage of protons and prevent the passage of electrons between said anode and said cathode;
electrically coupling said first metal coating with said second metal coating.
